(19) United States
(12) Patent Application Publication
(10) Pub. No.: US 2025/0151086 A1
(43) Pub. Date: May 8, 2025

(54) CHANNEL ACCESS SENSING AND FREQUENCY INTERLACING FOR SIDELINK COMMUNICATION

(71) Applicant: Intel Corporation, Santa Clara, CA (US)

(72) Inventors: Salvatore Talarico, Santa Clara, CA (US); Kilian Roth, Munich (DE); Alexey Khoryaev, Santa Clara, CA (US); Sergey Panteleev, Kildare (IE); Mikhail Shilov, Santa Clara, CA (US)

(21) Appl. No.: 18/833,369

(22) PCT Filed: Apr. 17, 2023
(86) PCT No.: PCT/US2023/065853

§ 371 Date: Jul. 25, 2024

Related U.S. Application Data
(60) Provisional application No. 63/332,178, filed on Apr. 18, 2022.
(60) Provisional application No. 63/332,109, filed on Apr. 18, 2022.
(60) Provisional application No. 63/407,408, filed on Sep. 16, 2022.
(60) Provisional application No. 63/408,344, filed on Sep. 20, 2022.
(60) Provisional application No. 63/485,382, filed on Feb. 16, 2023.

(51) Int. Cl. H04W 72/25; H04L 5/00; H04W 72/0453

(52) U.S. Cl. CPC H04W 72/25; H04L 5/0094; H04W 72/0453

(57) ABSTRACT

Various embodiments herein provide techniques for sidelink communication, e.g., in an unlicensed frequency band. For example, embodiments may relate to channel access sensing procedures, e.g., in association with a listen-before-talk (LBT) procedure for unlicensed spectrum. Embodiments may further relate to a frequency interlaced physical structure for sidelink communication. Other embodiments may be described and claimed.

### CROSS REFERENCE TO RELATED APPLICATION

The present application claims priority to U.S. Provisional Patent Application No. 63/332,178, which was filed Apr. 18, 2022; U.S. Provisional Patent Application No. 63/332,109, which was filed Apr. 18, 2022; U.S. Provisional Patent Application No. 63/407,408, which was filed Sep. 16, 2022; U.S. Provisional Patent Application No. 63/408,344, which was filed Sep. 20, 2022; and to U.S. Provisional Patent Application No. 63/485,382, which was filed Feb. 16, 2023.

### FIELD

Various embodiments generally may relate to the field of wireless communications. For example, some embodiments may relate to techniques for sidelink communication, such as in unlicensed spectrum.

### BACKGROUND

Mobile communication has evolved significantly from early voice systems to today's highly sophisticated integrated communication platform. The next generation wireless communication system, fifth generation (5G) (which may be additionally or alternatively referred to as new radio (NR)) may provide access to information and sharing of data anywhere, anytime by various users and applications. NR may be a unified network/system that target to meet vastly different and sometime conflicting performance dimensions and services. Such diverse multi-dimensional requirements may be driven by different services and applications.

For instance, in the third generation partnership project (3GPP) release-16 (Rel.16) specifications, sidelink (SL) communication was developed in radio access network (RAN) to support advanced vehicle-to-anything (V2X) applications. In release-17 (Rel.17), SA2 studied and standardized proximity based service including public safety and commercial related services and as part of Rel.17, power saving solutions (e.g., partial sensing, discontinuous reception (DRX), etc.) and inter-user equipment (UE) coordination have been developed to improve power consumption for battery limited terminals and reliability of SL transmissions. Although NR SL was initially developed for V2X applications, there is growing interest in the industry to expand the applicability of NR SL to commercial use cases, such as sensor information (e.g., video) sharing between vehicles with high degree of driving automation. For commercial SL applications, desirable features may include increased SL data rate and support of new carrier frequencies for SL. To achieve these elements, one objective in release-18 (Rel.18) is to extend SL operation in unlicensed spectrum (e.g., referred to as NR-U SL).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates New Radio-Unlicensed (NR-U) sidelink (SL) communication modes.

FIG. 2A illustrates switching times within a SL slot without a physical sidelink feedback channel (PSFCH), in accordance with various embodiments.

FIG. 2B illustrates switching times within a SL slot with a PSFCH, in accordance with various embodiments.

FIG. 3 illustrates examples of transmit (Tx)/receive (Rx) and Rx/Tx gaps (guard periods) in a sidelink physical structure, in accordance with various embodiments.

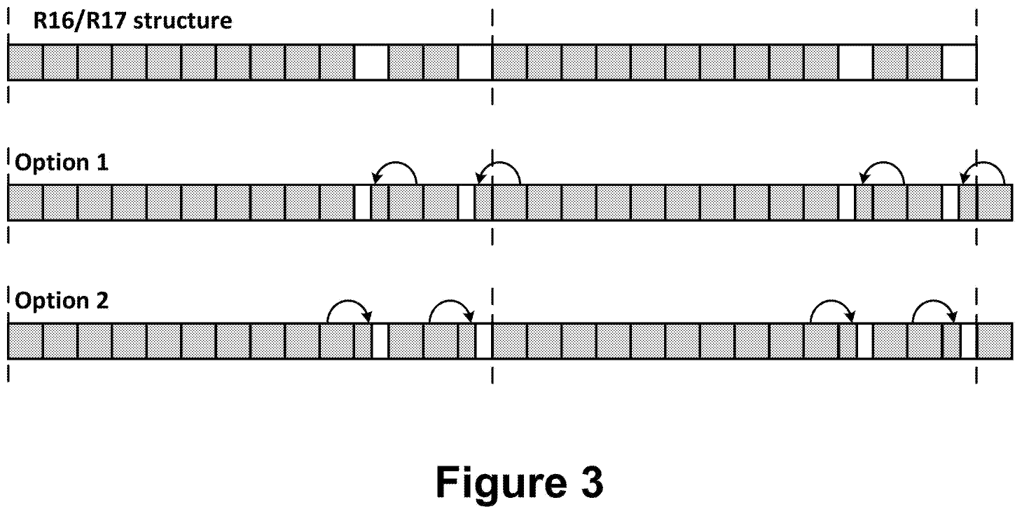

FIG. 4 illustrates examples of the applicability of cyclic prefix extension (CPE) to synchronization signal block (SSB) transmission when prior SL transmission to the sidelink SSB (S-SSB) transmission ends one symbol earlier, in accordance with various embodiments.

FIG. 5 illustrates examples of the impact of SL synchronization error, in accordance with various embodiments.

FIG. 6 illustrates examples of the impact of UE-UE propagation delay, in accordance with various embodiments.

FIG. 7 illustrates an example of two UEs competing for the same channel and performing LBT at the same time, in accordance with various embodiments.

FIG. 8 illustrates an example of two UEs that choose the same starting position for their transmission, and apply a different CPE and listen-before-talk (LBT) procedure beforehand to avoid collision between their transmissions, in accordance with various embodiments.

FIG. 9 illustrates an example of a general ON/OFF time mask for shared spectrum channel access, in accordance with various embodiments.

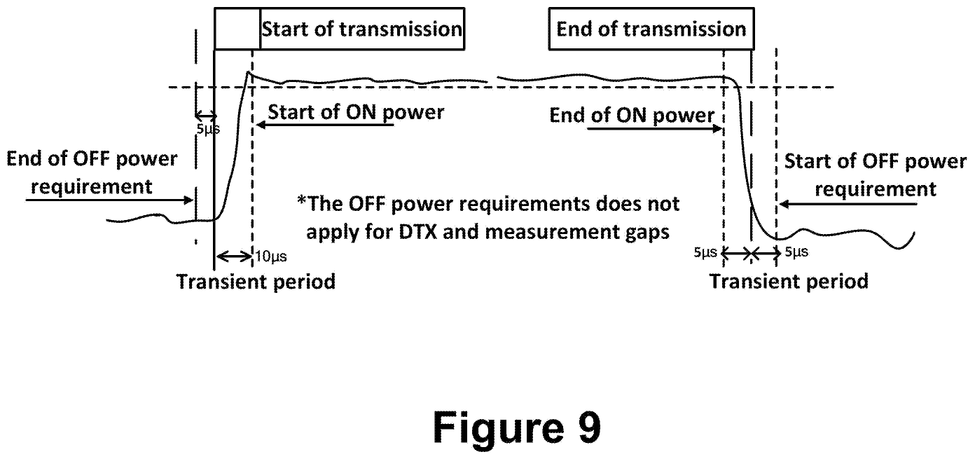

FIG. 10 illustrates examples of LBT window and ON/OFF (OFF/ON) transient period effecting a type 2B LBT, in accordance with various embodiments.

FIG. 11 illustrates an example of Type 2B LBT for SL communication in unlicensed spectrum, in accordance with various embodiments.

FIG. 12 illustrates an example of a physical channel structure with 20 MHz bandwidth (BW) and 30 kHz subcarrier spacing (SCS) (number of resource blocks (NRB)=51) where M=5; N=11 for int. #0 and N=10 for int. #1-4, in accordance with various embodiments.

FIGS. 13A and 13B illustrate an example of a physical channel structure with K=51 RBs and M=5 with both single RB interleaving options, in accordance with various embodiments.

FIG. 14 illustrates an example of a physical channel structure with K=51 RBs and M=5 with group RB interleaving, in accordance with various embodiments.

FIG. 15 illustrates an example of comb-5 sub-carrier (SC) interleaving, in accordance with various embodiments.

FIG. 16 schematically illustrates a wireless network in accordance with various embodiments.

FIG. 17 schematically illustrates components of a wireless network in accordance with various embodiments.

FIG. 18 is a block diagram illustrating components, according to some example embodiments, able to read instructions from a machine-readable or computer-readable medium (e.g., a non-transitory machine-readable storage medium) and perform any one or more of the methodologies discussed herein.

FIG. 19 depicts an example procedure for practicing the various embodiments discussed herein.

FIG. 20 depicts another example procedure for practicing the various embodiments discussed herein.

FIG. 21 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Embodiments herein provide techniques for sidelink communication, e.g., in an unlicensed frequency band. For example, embodiments may relate to channel access sensing procedures. Embodiments may further relate to a frequency interlaced physical structure for sidelink communication.

As discussed above, one objective in release-18 (Rel.18) is to extend SL operation in unlicensed spectrum (referred to herein as NR-unlicensed (NR-U) SL spectrum). However, it is noted that to allow fair usage of the spectrum and fair coexistence among different technologies, different regional regulatory requirements are imposed worldwide. Thus, to enable a solution for all regions complying with the strictest regulation from ETSI BRAN published in EN 301 893 may be sufficient. In fact, for the development of NR-U during Rel. 16 a 3GPP NR based system complying with these regulations was developed.

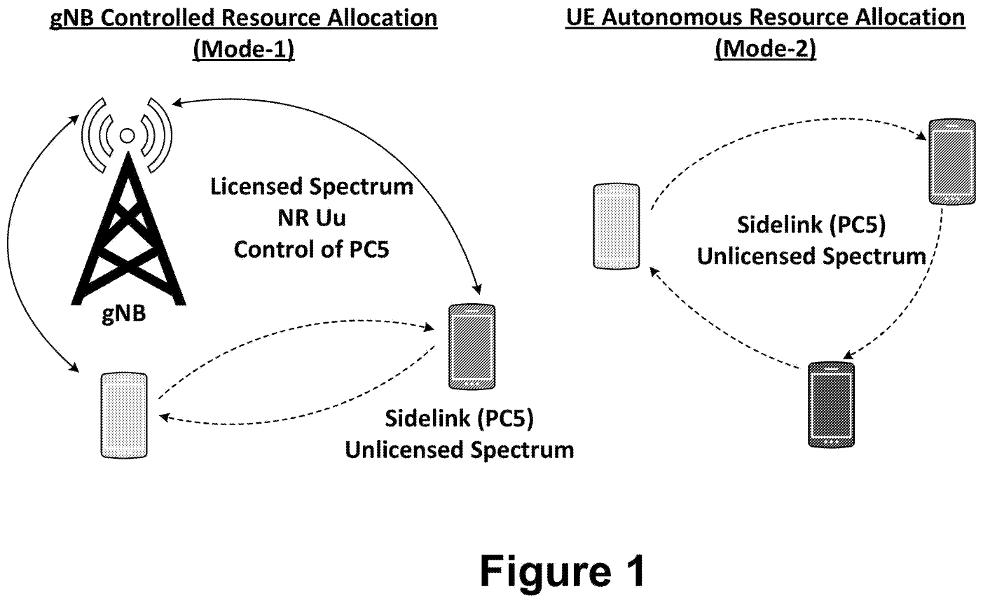

With that said, to enable a SL communication system in the unlicensed band, the considerations of SL communication systems may need to be combined with the regulator requirements necessary for the operation in the unlicensed bands. In particular, it is noted that NR SL could operate through two modes of operation: 1) mode-1, where a gNB schedules the SL transmission resource(s) to be used by the UE, and Uu operation is limited to licensed spectrum only; 2) mode-2, where a UE determines (e.g, gNB does not schedule) the SL transmission resource(s) within SL resources which are configured by the gNB/network or pre-configured. FIG. 1 illustrates the two modes of operation.

In this context, there are several specific challenges to enable NR-U SL.

### Channel Access Sensing Procedure

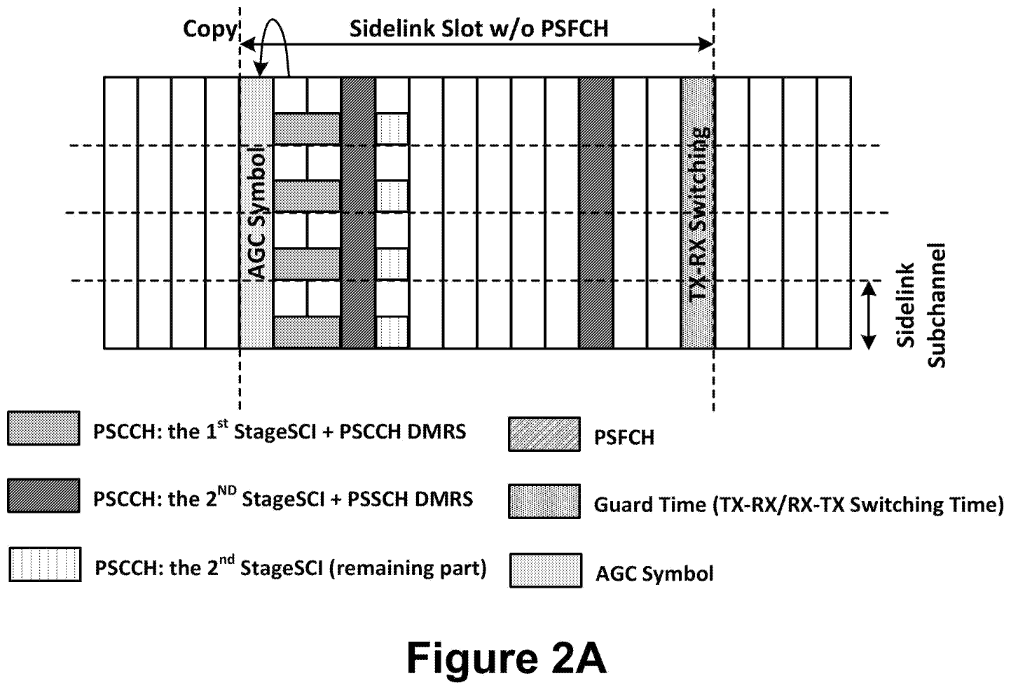

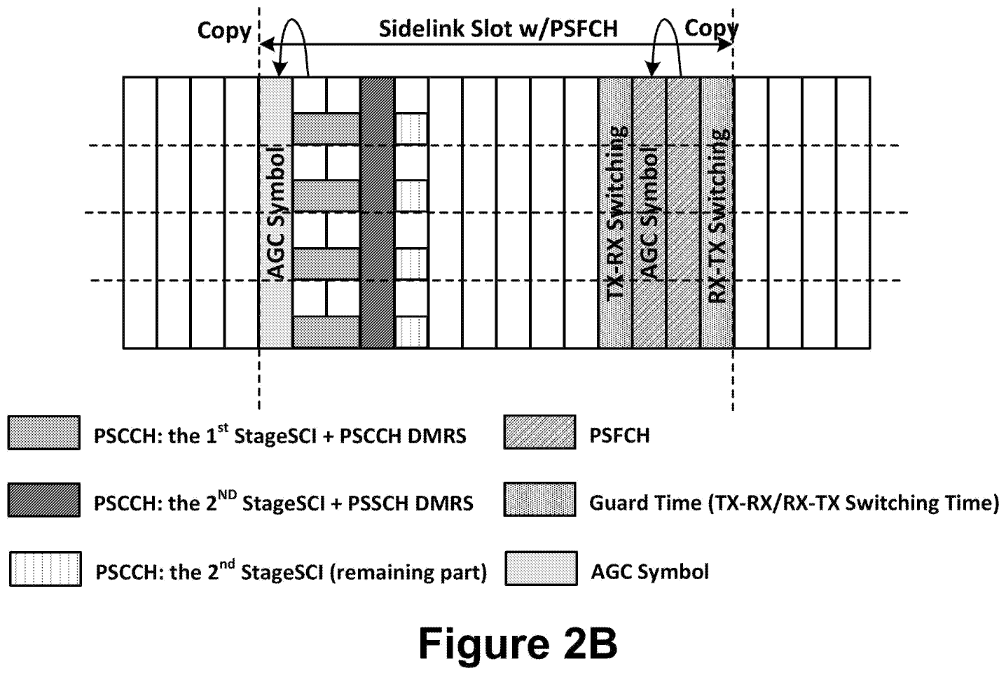

In SL, the concept of SL slot has been introduced together with the transmit/receive (TX/RX) and RX/TX switching gaps, which have been defined as guard interval for proper RF retuning at the UE when switching from RX mode to TX mode and vice versa. As example of SL slot is illustrated in FIGS. 2A-2B. FIG. 2A depicts the case of a SL slot without a physical sidelink feedback channel (PSFCH), while FIG. 2B provides an example of SL slot with PSFCH.

As shown in FIGS. 2A-2B, at least 1 symbol gap will be present in a SL system, which in unlicensed band is synonymous of LBT overhead, since in FR-1, when a gap larger than 16 us exists among bursts within a channel occupancy time (COT) then regardless of whether the system operates in semi-static or dynamic channel access mode an LBT mechanism is needed at either the initiating and/or the responding device to resume transmission or to start a transmission after that gap. Various embodiments herein provide techniques to mitigate this issue.

Another issue to consider regarding a SL slot is that in SL all transmissions start at a predefined symbol positions within a slot, and the first symbol of each SL transmission is a replica of the second symbol, where such physical structure was defined to support automatic gain control (AGC) convergence time. However, due to the fact that LBT may be required in unlicensed spectrum and potential LBT failures may occur, additional flexibility is needed on when a SL transmission may be initiated. In this matter, multiple options are discussed in this disclosure.

Accordingly, embodiments herein provide mechanisms to handle the gaps left in SL for RX/TX and TX/RX switching gap when operating in unlicensed spectrum. Furthermore, embodiments herein provide mechanisms to mitigate mutual blocking across UEs when operating in either TDM or FDM mode.

### TX/RX & RX/TX Switching Gaps

As discussed above, SL physical structure defines one symbol for TX/RX and RX/TX switching gaps (also called guard period). The actual duration needed for these TX/RX and RX/TX switching gaps have been determined by RAN4, and they may be less than 13 us. However, the allocated duration for the TX/RX and RX/TX switching gaps depends on the subcarrier spacing (SCS) settings (e.g., OFDM symbol duration without CP is equal to 66.6/33.3 and 16.6 us for 15/30/60 kHz SCS, respectively) and is larger than the actual time needed.

When operating in unlicensed spectrum, for efficient LBT operation and to reduce LBT overhead within SL COT sharing interval, the gaps among transmission bursts within the COT should be less than or equal to 16 us, so that no LBT may be needed for both dynamic and semi-static channel access mode. If the gap is larger than 16 us, then Type-2A or 2B LBT procedures may be needed within a shared COT.

To reduce the TX/RX and RX/TX switching gaps defined in SL physical structure when operating in unlicensed spectrum, in one embodiment, one of the following options may be adopted:
Option 1: a SL transmission may start earlier than the symbol/slot boundary (e.g., cyclic prefix extension is used, or any other reference or data signal is added);
Option 2: a SL transmission ends a later time than the symbol boundary (e.g., cyclic postfix extension is used, or any other reference or data signal is added).

### (Option 1: Cyclic Prefix Extension and Option 2: Cyclic Postfix Extension)

In one embodiment, if option 1 or option 2 above is adopted, it is left up to UE's implementation to determine the length of the cyclic prefix or postfix to apply. In another option, the cyclic prefix extension to apply so that to mitigate the gaps length is indicated in SL mode 1 within the scheduling DCI 3_x. In another option, the cyclic postfix applied by a UE is indicated within the SL control indication (SCI) (in either stage-1 or stage 2 or both).

Regardless of whether the TX/RX and RX/TX switching time is reduced or one of the options above is not used, it may be important to define the UE's behavior in terms of LBT procedure in presence of such a gap. In this sense, the features may be decoupled based on whether the SL slot may or may not include a PSFCH transmission.

Case without PSFCH

In one embodiment, when the SL slot may not include a PSFCH, one of the following options could be adopted:
Option 1: If the gap deriving from TX-RX time is occurring within a COT together with the follow up transmission (e.g., other burst from gNB or same UE, or other UE through PSFCH transmission), it is left up to implementation to make sure if LBT may be needed there is always a sufficient gap between the UL burst and the follow up burst to perform LBT.
Option 2: The TX-RX switching times is adjusted for 60 kHz to be at least 2 symbols to guarantee a minimum gap of 25 us, so that LBT is always needed regardless of SCS and scenarios, and no need to handle gaps length from UE's point of view via cyclic prefix or post prefix.
Option 3: The TX-RX switching times are left as defined in Rel-16, and a UE performing transmission after the gap determines the specific length of such a gap by decoding the SCI from the prior burst and specifically by knowing the time domain resource used for the prior burst and the time domain resources used for the following intended transmission. After knowing the specific length of such a gap, the UE may choose the LBT type to use according to the one or more of the following rules:
   If the UE operates in dynamic channel access mode, and if the gap is larger than 16 us but smaller than 25 us, then LBT type 2B is used.
   If the UE operates in dynamic channel access mode, and if the gap is larger than 25 us, then LBT type 2A is used.
   If the UE operates in semi-static channel access mode, and if the gap is larger than X us, then the UE may perform an LBT procedure using an observation window of X us, where X=9 us or may be equal to 16 us in China or in other regions where an observation window of such a length is required.
      Case with PSFCH

When the SL slot may include a PSFCH, different consideration may be made separately depending on whether the gap may be related to TX/RX and RX/TX switching.

In one embodiment, when the SL slot may include a PSFCH, for the TX/RX switching time one of the following options could be adopted:
Alt 1: the switching time is left as is, and no enhancements are applied
Alt-2: the switching time is adjusted for 60 kHz to be at least X symbols to guarantee a minimum gap of 25 us, so that LBT is always needed regardless of SCS and scenarios, and no need to handle gaps length from UE's point of view via CP extension. In one embodiment, X is fixed and for example equal to X=2. In another embodiment, X is configured through higher layer.
   Also notice that:
      For semi-static channel access mode, 1 symbol for 60 kHz may be sufficient if either the UE transmitting PSFCH is a responding device or initiating device since the sensing should be 9 us long. In this case, in one embodiment, based on whether semi-static channel access mode and dynamic channel access mode is used, a different switching time length may be used.
      Special consideration may also be needed in China, where the minimum sensing is 16 us. In this case, in one embodiment, a cell-specific RRC signaling may be needed to distinguish between regional deployments, and additional differentiation for the RX/TX and TX/RX switching times can be also done based on whether this parameter is configured or not. As an example, if the system operates semi-static channel access mode and it operates in China or any other country where a minimum sensing of 16 us is need, X=2 may be configured or used, otherwise X=1 may be configured or used.
The RX-TX switching time

In one embodiment, when the SL slot may include a PSFCH, for the RX/TX switching time one of the following options may be used:
Alt 1: the switching time is left as is, and no enhancements are applied
Alt-2: the switching time is adjusted for 60 kHz to be at least X symbols to guarantee a minimum gap of 25 us, so that LBT is always needed regardless of SCS and scenarios, and no need to handle gaps length from UE's point of view via CP extension. In one embodiment, X is fixed and for example equal to X=2. In another embodiment, X is configured through higher layer.
   Further aspects may include:
      For semi-static channel access mode, 1 symbol for 60 kHz may be sufficient if either the UE transmitting PSFCH is a responding device or initiating device since the sensing should be 9 us long. In this case, in one embodiment, based on whether semi-static channel access mode and dynamic channel access mode is used, a different switching time length may be used.
      Special consideration may be also needed in China, where the minimum sensing is 16 us. In this case, in one embodiment, a cell-specific RRC signaling may be needed to distinguish between regional deployments, and additional differentiation for the RX/TX and TX/RX switching times can be also done based on whether this parameter is configured or not. As an example, if the system operates semi-static channel access mode and it operates in China or any other country where a minimum sensing of 16 us is need, X=2 may be configured or used, otherwise X=1 may be configured or used.

In one embodiment, regardless of the SCS, PSFCH is qualified as short control signaling, and one of the following options may be used:
Option 1: No LBT is needed for PSFCH and the 5% duty cycle is applied for device, meaning that the UE transmitting PSFCH will be responsible to meet the 5%, otherwise LBT will be needed for any additional PSFCH transmission.
Option 2: No LBT is needed for PSFCH and the 5% duty cycle is applied per “initiating” device, meaning the 5% is counted independently of the UE transmitting PSFCH by the UE that is initiating the COT, and it is left up to gNB's or initiating UE to indicate whether LBT or not LBT is needed.
Option 3: No LBT is needed for PSFCH and the 5% duty cycle is applied per “cell”, meaning the 5% is counted independently of the UE transmitting PSFCH by the serving gNB, and it is left up to gNB's to indicate whether LBT or not LBT is needed.
Option 4: if the UE operates in dynamic channel access mode, type 2A LBT is used before PSFCH is transmitted if the gap within a shared COT among a prior burst and the transmission of PSFCH is larger than 25 us or if the PSFCH falls outside of any other UE's or that UE's COT.

Another issue that may be considered is when the PSFCH is transmitted as if the UE is the initiating device, and the starting point of the COT aligns with the PSFCH transmission. In this case, in many scenarios the UE will not be able to perform any LBT (either type 1 or type 2A/2B), since the prior burst to the PSFCH transmission may block the LBT procedure. In this matter, in one embodiment, one of the following options may be used:
Option 1: No special handling is supported, and UE as initiating device at the boundary of a PSFCH transmission is avoided via proper scheduling when possible.
Option 2: PSFCH transmission is allowed only if one or more of the following is satisfied:
   PSFCH transmission occurs within a shared COT from another device (gNB's or other UE's COT).
   PSFCH occurs within the transmitting UE's COT, if the COT has been initiated prior to the PSFCH transmission.

In one embodiment, right before a PSFCH transmission may occur (e.g., right before the start of the allocated resources for PSFCH) a UE may apply a cyclic prefix extension of length

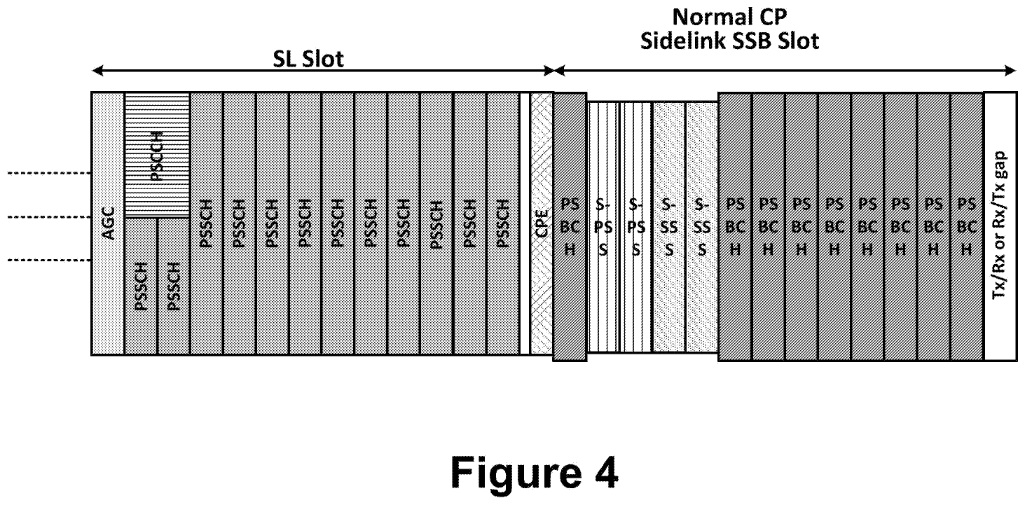

T_(symb,(l−1)mod 7·2\hat{ }μ)/\hat{ }μ−Y

where l is the OFDM symbol where the cyclic prefix extension may be applied, μ identifies the subcarrier spacing (e.g., μ=0 corresponds to 15 kHz, μ=1 corresponds to 30 kHz, and μ=2 corresponds to 60 kHz), and Y, as an example may be fixed and equal to 13 us or may be some other value in other embodiments such as less or equal to approximately 16 us if the UE transmitting PSFCH is able to operate as responding device within its own or another UE's COT. This option may be applied, for example, when a UE detects that its PSFCH transmission may occur within a shared COT and additionally that within the SL slot in which the PSFCH transmission would occur another UE may perform a PSSCH/PSCCH transmission ending one symbol before this PSFCH transmission as illustrated in the right figure of FIG. 2. In one embodiment, as an alternative the value of Y is (pre-) configured or may be decided by the UE based on UE's implementation. In one embodiment, even if Y may be provided by (pre-) configuration, its values may be pre-defined or fixed in the condition where a UE assesses that its S-SSB transmission could occur within a shared COT, and determines that a prior SL transmission (either PSSCH/PSCCH or PSFCH) from itself or another UE may end one symbol before the start of the S-SSB transmission as illustrated in FIG. 4.

In one embodiment, no cyclic prefix extension is applied before a PSFCH transmission when a UE performs this transmission outside a shared COT. In this case, whether a UE may perform type 2A or type 1 LBT, this may end right before the first symbol of the PSFCH transmission (e.g., the type 2A and type 1 LBT are performed so that assessment of whether a channel is idle or occupied would occur right before the PSFCH transmission).

In one embodiment, a cyclic prefix extension is applied before a PSFCH transmission when a UE performs this transmission inside a shared COT, and when the prior transmission may end more than 1 symbol earlier. In this case, the length of the cyclic prefix extension may be either up to UE's implementation or based upon a (pre-configured value).

Notice that some of the options/embodiments provided above are not mutually exclusive but can be jointly adopted.

Cyclic Prefix Extension for S-SSB within a Shared COT:

In one embodiment, S-SSB can be transmitted either within or outside a COT, and if its transmission occurs outside a COT, a type 2A LBT may be used if one or more of the following conditions is met:
S-SSB transmission is at most 1 ms long
Its duty cycle is at most 1/20
The duty cycle is calculated over an observation period of 50 ms

When a UE assesses that its S-SSB transmission could occur within a shared COT, in one embodiment a UE may append a cyclic prefix extension before the start of an S-SSB transmission in the symbol right before of length

$${T}_{symb , ( l - 1 ) mod 7 \cdot {2}^{μ}}^{μ} - Y$$

if it also determines that a prior SL transmission (either PSSCH/PSCCH or PSFCH) from itself or another UE may end one symbol before the start of the S-SSB transmission as illustrated in FIG. 4.

In one embodiment, l is the OFDM symbol where the cyclic prefix extension may be applied, μ identifies the subcarrier spacing (e.g., μ=0 corresponds to 15 kHz, μ=1 corresponds to 30 kHz, and μ=2 corresponds to 60 kHz), and Y as an example may be fixed and equal to 13 us or may be generally less or equal than 16 us if the UE transmitting S-SSB is able to operate within its own or another UE's COT. In one embodiment, as an alternative the value of Y is (pre-) configured within each resource pool or may be decided by the UE based on UE's implementation. In one embodiment, even if Y may be provided by (pre-) configuration, its values may be pre-defined or fixed in the condition where a UE assesses that its S-SSB transmission could occur within a shared COT, and determines that a prior SL transmission (either PSSCH/PSCCH or PSFCH) from itself or another UE may end one symbol before the start of the S-SSB transmission as illustrated in FIG. 4.

In one embodiment, no cyclic prefix extension is applied before an S-SSB transmission when a UE performs this outside a shared COT. In this case, whether a UE may perform type 2A or type 1 LBT, this may end right before the first symbol of the S-SSB transmission (e.g., the type 2A and type 1 LBT are performed so that assessment of whether a channel is idle or occupied would occur right before the S-SSB transmission).

In one embodiment, a cyclic prefix extension is applied before an S-SSB transmission when a UE performs this transmission inside a shared COT, and when the prior transmission may end more than 1 symbol earlier. In this case, the length of the cyclic prefix extension may be either up to UE's implementation or based upon a (pre-configured value).

In one embodiment, the conditions for which type 2C may apply could be relaxed for SL-U. For instance, a type 2C could be applied within a shared COT independently of the length of the transmission, which does not need to be necessarily shorter than 584 us.

### Sidelink AGC Considerations for Unlicensed Spectrum Operation

In NR design, all SL transmissions start at a predefined symbol positions within a slot. Furthermore, the first symbol of each SL transmission is a replica of the second symbol, where such physical structure was defined to support AGC at each slot following the RAN4 input on AGC convergence time. However, operating channel access at fixed/predefined position in time is not suitable for operation in unlicensed spectrum with incumbent technologies since those can access the channel at arbitrary time and across slot boundaries.

In one embodiment, channel access at arbitrary time with sub-symbol granularity is supported, where AGC may be invoked at any time within slot when significant received signal power change is observed. In another option, such behavior can be avoided, if there is no incumbent technology deployed (e.g., absenceOfAnyOtherTechnology is indicated).

In one embodiment, of the following options could be adopted:
Option 1: All SL transmissions start at a predefined symbol position within a slot;
Option 2: A SL transmission can start at any symbol within a slot or a predefined or configurable set of symbols;
Option 3: A SL transmission can be configured to either start at a given predefined symbol position or within a predefined set of starting positions (or can start at any symbols within a slot).

In one embodiment, CP extension could be applied by a UE before a SL transmission, and this is used to enable additional time for preparation of the actual waveform for PSCCH and/or PSSCH transmission.

In one embodiment, the AGC symbol could be elongated and could be fit to ensure immediate transmission occurs soon after the LBT has been successfully performed by assessing that a channel is empty.

In one embodiment, different options, and different embodiments among those described above may apply depending on whether the SL transmission may occur within or outside of a shared COT.

In one embodiment, the start of the OFDM symbol in a slot is shifted to adjust the TX/RX gap and jointly use the extended CP for AGC adaptation.

In one embodiment, AGC adaptation is omitted as the transmissions only start with a PSCCH during and the AGC is adjusted during the reception of the PSCCH.

In one embodiment, the AGC is adjusted during the transmission of anything not meant of demodulation.

Note that some of the options/embodiments provided above are not mutually exclusive but can be jointly adopted.

### Potential Impact of SL Synchronization on LBT Operation

As mentioned above according to RAN4, the upper bound for TX/RX and RX/TX switching time is 13 us in FRI and 7 us in FR2. The UE typically also has an ON/OFF and OFF/ON transient period in the order of 10 us. Furthermore, the UE may also incur into SL synchronization errors (e.g., GNSS sync error or gNB synchronization error), and the gNB SL synchronization additionally include propagation delay that for macro cell deployments can be in the order of several us (e.g. 2 us or 4 us for gNB-UE distance of 600 m and 1200 m respectively). In addition, the gNB synchronization error may be in the order of up to 3 us.

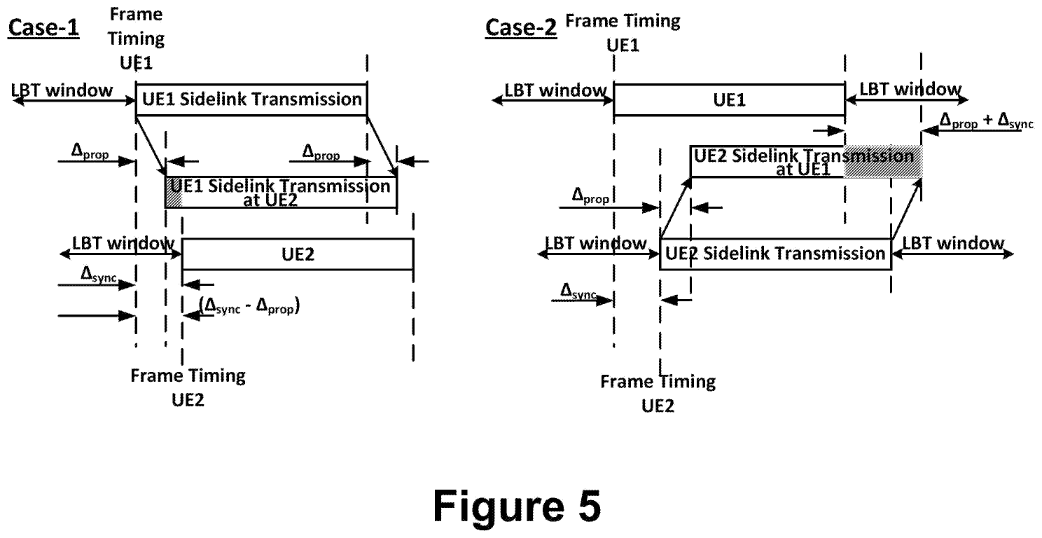

For SL operating in unlicensed band the LBT procedure may be needed, and a UE is expected to perform energy measurements within specific instances of time. However, due to the aforementioned errors, UEs may end up blocking each other as illustrated as an example in FIG. 5 based on the following two cases:
Case 1: a UE2 may be blocked by UE1 transmission depending on the position of LBT type of UE2, the propagation delay between UE2 and UE1, Δₚᵣₒₚ, and the location of the energy measurement interval (observation windows) within the LBT window of UE2. In this case propagation delay from UE1 to UE2 is in favor of UE2, and plays a positive role.
Case 2: a UE1 may be blocked by UE2 on any follow up transmission depending on the LBT type, the propagation delay between UE2 and UE1, Δₚᵣₒₚ, and the location of the energy measurement interval (observation windows) within the LBT window of UE1. In this case propagation delay from UE2 to UE1 is not in favor of UE1, and plays a negative role.

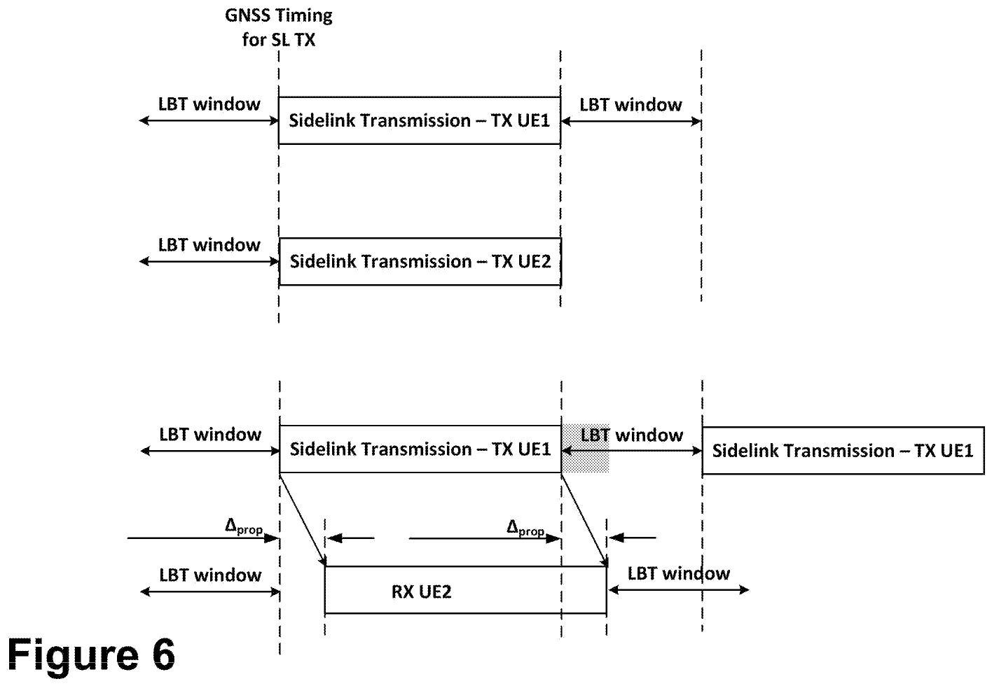

Furthermore, even if two or multiple UEs may attempt to align their starting transition time, and the synchronization errors may be negligible, blocking among them may still occur due to propagation delays as illustrated in FIG. 6.

In one embodiment, FDM among SL UE is not supported when operating in unlicensed spectrum, and SL is only operated in TDM manner.

In one embodiment, in order to mitigate the aforementioned issue, FDM among SL UE is supported, and the LBT windows and energy measurement intervals (observation windows) within the LBT windows are aligned across UEs so that avoid mutual blocking.

In particular, when perfect alignment among UEs is not possible due to the aforementioned issues, in one embodiment, one or more of the following could be adopted to mitigate the cross-UEs mutual blocking:
Option 1: sub-channel based LBT or interlace-based LBT is used when OCB must be met. In this case, during the LBT procedure at a UE the energy measurement is only evaluated/performed within the sub-channel(s) or the interlace(s) used by that UE for SL transmission.
Option 2: LBT is still performed over chunks of 20 MHz LBT BW, but the ED threshold is adjusted so that in the case of FDM even if the head of a transmission performed by a UE may overlap with the LBT window of another UE, mutual blocking may be minimized. For instance, in the case of FDM, the ED threshold is lowered even further by either a fix value or by simply using in the EDT threshold calculation the effective bandwidth over which a UE may be transmitting.
Option 3: In FDM, the LBT procedure or structure could be modified so that to mitigate mutual blocking:
   Option 3a: the LBT window is performed in advance by a UE by considering the possible worst-case scenario (the drawback is that transmission may not happen right away). For instance, assuming the error case of 3 us, then all LBT window should be initiated 3 us+LBT window before a transmission.
      This can be easily applied for dynamic and semi-static channel access mode via implementation.
   Option 3b: For semi-static channel access mode the 4 us measurement is mandate always in the first 4 us of the 9 us measurement window. This will allow a device to neglect any energy measurement toward the tail of the LBT window which may be caused by transmissions misalignments. Similar approach could be applied in dynamic channel access mode to Type-1, Type-2a and 2b, but the results may not be as effective and deterministic as for semi-static channel access mode.

In one embodiment, in order to ensure that UEs are able to operate in FDM mode within a carrier (e.g., 20 MHz channel bandwidth) or across carriers, they are imposed to terminate their LBT procedure at the same time, and if LBT succeeds initiate transmission in the same instance. To ensure this type of operation, a cyclic prefix extension (CPE) could be appended before each transmission of each UE within a carrier or across carriers, so that UEs may not block each other during the LBT procedure, and upon termination of the LBT be able to transmit. In one option, the CPE length is equivalent to

T_(symb,(l−1)mod 7·2\hat{ }μ)\hat{ }μ−Y

where 1 is the OFDM symbol where the cyclic prefix extension may be applied, u identifies the subcarrier spacing (e.g., μ=0 corresponds to 15 kHz, μ=1 corresponds to 30 kHz, and μ=2 corresponds to 60 kHz). As for the value of Y, one or more of the following options could be adopted:

Y is (pre-) configured based on a pre-defined or (pre-) configurable set of values, which as an example could be {16 us, 25 us, 34 us, 43 us, 52 us, 61 us or T_(symb, (l−1) mod 7·2\hat{ }μ)\hat{ }μ}

Y is selected by UE's implementation across a set of pre-defined or (pre-) configurable set of values, which as an example could be {16 us, 25 us, 34 us, 43 us, 52 us, 61 us or T_(symb, (l−1) mod 7·2 \hat{ }μ)\hat{ }μ}.

Y is selected by UE's implementation.

Y is (pre-) configured based on a pre-defined or (pre-) configurable set of values, which as an example could be {16 us, 25 us, 34 us, 43 us, 52 us, 61 us or T_(symb, (l−1) mod 7·2\hat{ }μ)\hat{ }μ} which depends on the priority of the transmission. In other words, there may be a different (pre-) configured cyclic prefix extension based on the priority of the transmission, and a UE may apply the cyclic prefix extension based on the priority of the current transmission.

Y is selected by UE's implementation across a set of pre-defined or (pre-) configurable set of values, which as an example could be {16 us, 25 us, 34 us, 43 us, 52 us, 61 us or T_(symb, (l−1) mod 7·2\hat{ }μ)\hat{ }μ} which depends on the priority of the transmission. In other words, there may be a different (pre-) configured cyclic prefix extension based on the priority of the transmission, and a UE may apply the cyclic prefix extension based on the priority of the current transmission.

In one embodiment, the aforementioned cyclic shift prefix is appended only for UEs operating in RA mode 2. As an alternative, the aforementioned cyclic shift prefix is appended irrespective of the RA mode in which a UE is operating with. In one embodiment, the aforementioned cyclic shift prefix is appended only for UEs operating outside a shared COT. As an alternative, the aforementioned cyclic shift prefix is appended irrespective of whether a UE may operate outside or within a shared COT, which may belong to itself or to another UE.

### Randomized or Pseudo-Randomized the LBT Window

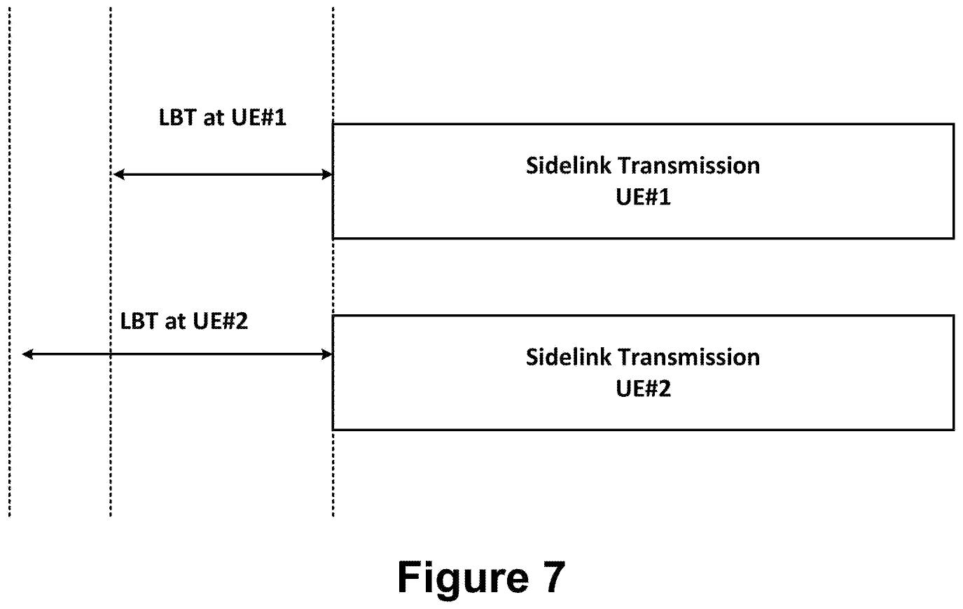

When operating in TDM mode, it could happen that two UEs may select the same set of resources from the resource pool or a set of resources which lead to the same starting time for their transmissions. In this case, by performing LBT at the same time, the two UEs may not be able to hear each other, and while able to successfully assess that the channel is idle and transmit (by potentially even acquiring an overlapping COT), their transmission may collide with each other, as illustrated in FIG. 7.

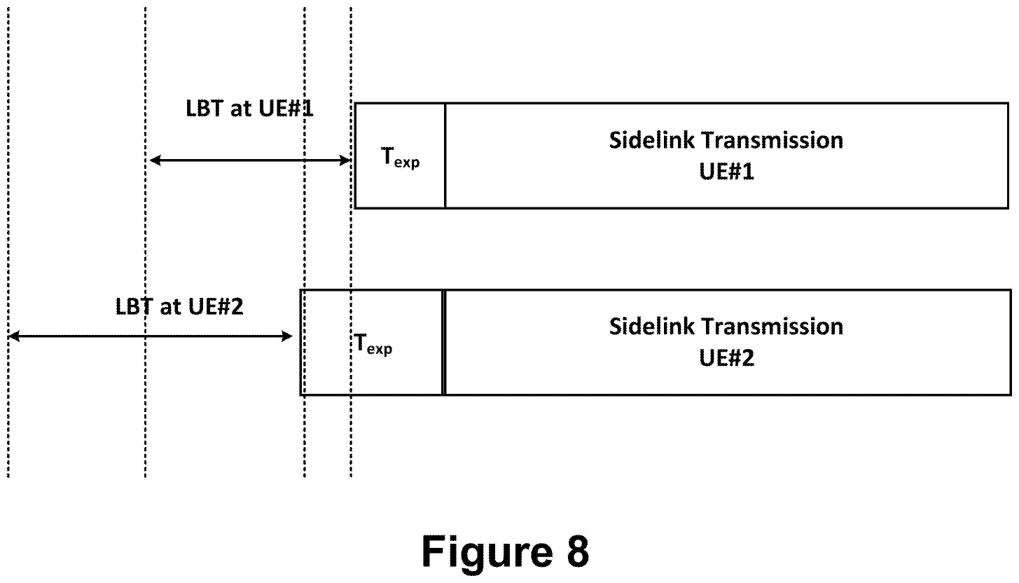

In order to mitigate mutual interference, in one embodiment, a CP extension could be applied before the actual transmission burst starts and the length of the CP extension could be randomly picked by each UE (e.g., from a predefined set of values) so that to randomize the starting position of the each transmission so that to make sure that one UE will not block the other during the LBT procedure, and their transmissions will never collide. This mechanism is illustrated in FIG. 8.

In general case, in one embodiment, UEs can use LBT measurement bandwidth aligned with either their transmission bandwidth or structure of frequency sub-channels to determine whether they can access channel on any of the frequency resources.

In one embodiment, the mechanism defined above could be implemented by using same principles as Rel-16 CG intra-symbol starting positions, and the CP extension to use could be defined as follows:

$${T}_{ext} = {\sum }_{k = 1}^{{2}^{μ}} {T}_{symb , ( l - k ) mod 7 \cdot {2}^{μ}}^{μ} - {Δ}_{i} ,$$

where μ identifies the subcarrier spacing (e.g., μ=0 corresponds to 15 kHz, μ=1 corresponds to 30 kHz, and μ=2 corresponds to 60 kHz) and Δᵢ links to a set of predefined values, which as an example could be defined as in the following table:

| index i | Δᵢ |
|---|---|
| 0 | 16 · 10⁻⁶ |
| 1 | 25 · 10⁻⁶ |
| 2 | 34 · 10⁻⁶ |
| 3 | 43 · 10⁻⁶ |
| 4 | 52 · 10⁻⁶ |
| 5 | 61 · 10⁻⁶ |
| 6 | Σ^{^{2μ}}_{_{K = 1}} T^{μ}_{symb,(l - k)mod 7 · 2}^{μ} |

In one embodiment, the aforementioned cyclic shift prefix is appended only for UEs operating in RA mode 2. As an alternative, the aforementioned cyclic shift prefix is appended irrespective of the RA mode in which a UE is operating with. In one embodiment, the aforementioned cyclic shift prefix is appended only for UEs operating outside a shared COT. As an alternative, the aforementioned cyclic shift prefix is appended irrespective of whether a UE may operate outside or within a shared COT, which may belong to itself or to another UE.

In one embodiment, no cyclic prefix extension is applied when a UE performs a SL transmission outside a shared COT. In this case, independently on the type of LBT performed by the UE, this may end right before the first symbol of the SL transmission (e.g., LBT is performed so that assessment of whether a channel is idle or occupied would occur right before the actual SL transmission).

In one embodiment, a UE may apply one or more of the following criteria to select a cyclic prefix extension to be appended before its transmission:
A UE randomly selects the cyclic prefix extension to apply before its transmission by randomly picking among the fixed/pre-defined set of values or across a subset of values which is (pre-) configured and whose values are selected from a pre-defined set of values.
A UE may select the cyclic prefix extension to apply based on the priority of the transmission. For instance, a pre-defined set of cyclic prefix extension values are defined and each or a group of them are associated with a specific priority level.
Different set of values could be defined based on whether a transmission occurs within or outside a COT.

In one embodiment, the aforementioned method could be only applicable to one or more of the following types of SL transmissions:
PSSCH/PSCCH
PSFCH
S-SSB

### ON/OFF and OFF/ON Transient Time Considerations for Unlicensed Spectrum Operation

As discussed herein, when operating in unlicensed spectrum the LBT procedure may be mandated. In particular, energy measurements must be performed within an LBT window if the time gap between subsequent SL transmissions exceeds or equal to 16 us. Furthermore, according to RAN4 requirements, NR transmissions have ON/OFF and OFF/ON transient periods which are bounded by T_{ONOFF}=10 us as for operation in unlicensed spectrum the mask illustrated in FIG. 8 has been defined:

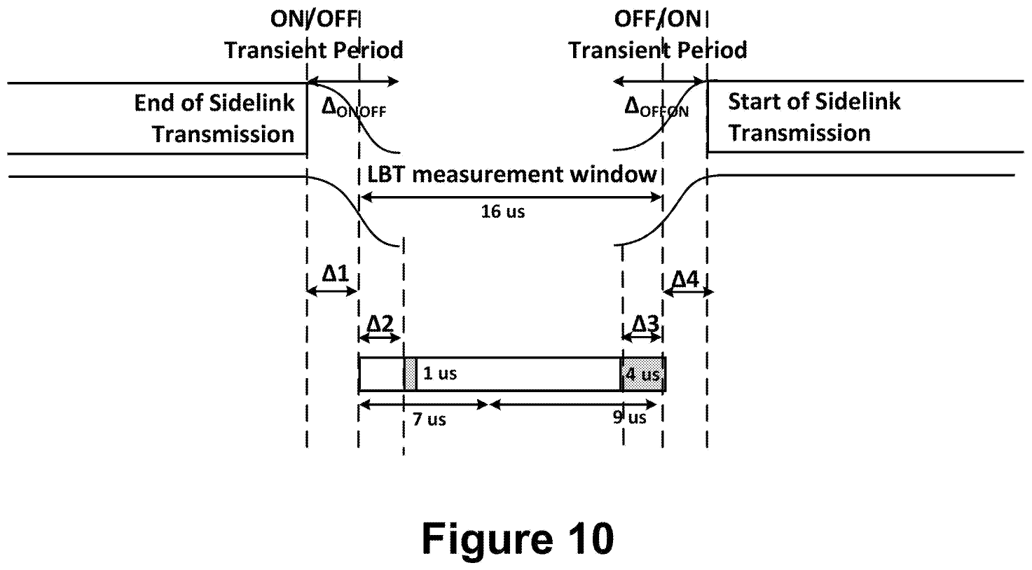

With that said, to avoid measurements of transient effect within LBT windows as depicted in FIG. 10, some special considerations should be made in this regard.

In one embodiment, the minimum gap between consecutive SL transmission requiring LBT should be readjusted to account for ON/OFF and OFF/ON transient periods. For instance for dynamic channel access mode, the minimum gap should be at least T_{ONOFF}/2 (5 us)+T_{LBT} (16 us)+T_{OFFON}/2 (5)=26 us (or 21 us if the 5 us of the OFF-ON are incorporated by implementation in the LBT procedure by performing the 4 us measurement 5 us before the end of the observation period). For semi-static channel access mode, the minimum gap should be at least T_{ONOFF}/2 (5 us)+T_{LBT} (X us)+T_{OFFON}/2 (5)=X=10 us (or X+5 us if the 5 us of the OFF-ON are incorporated by implementation in the LBT procedure by performing the 4 us measurement 5 us before the end of the observation period), where X=9 us except for China or any other regions where a minimum observation window of X=16 us is required.

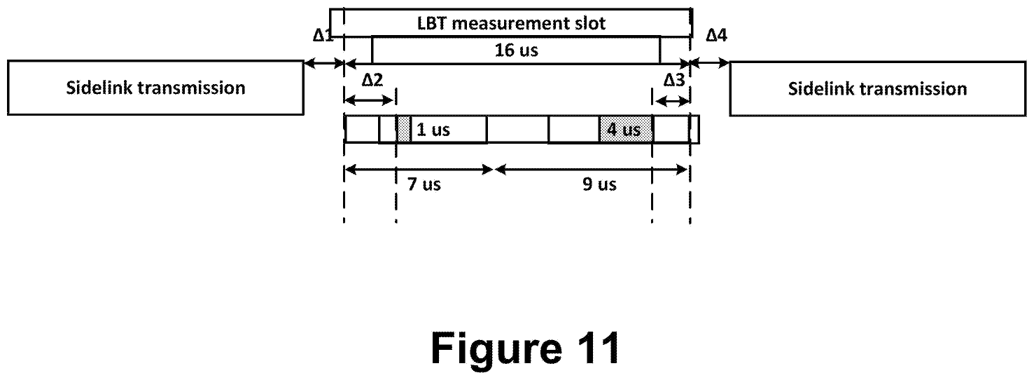

In one embodiment, the location of the measurement windows within the observation windows of an LBT procedure are modified so that to account for the ON/OFF and OFF/ON transient periods, and the location of the measurements windows are pre-configured by specification or by gNB/network or selected properly by UE's implementation. As an example of this method, the type 2B LBT depicted in FIG. 11 is modified according to one of the following options:
Option 1: Values of parameters Δ1, Δ2, Δ3, Δ4 are left up to UE implementation
Option 2: Values of Δ1, Δ2, Δ3, Δ4 are pre-configured by gNB/network
Option 3: Bounds for values of Δ1, Δ2, Δ3, Δ4 are pre-defined by specification

Notice that the example above could be applied straightforwardly to any other LBT types.

The above issue may not be critical for UL-to-UL transmission switch among different devices, since there may always be a sufficient gap across SL transmissions from different UEs that the ON/OFF and OFF/ON transient times would not impact the LBT procedure, in NR-U SL, UL-to-UL transmission switch from the very same device are actually very commonly due to PSFCH transmissions, and depending on the gap between bursts, a device may indeed block itself. For example, for 60 kHz SCS, one symbol gap is equivalent to ˜16 us, but when performing 16 us LBT due to the 5 us transient time from end of first burst, and start of the following burst, the second burst may be blocked from being transmitted. In order to mitigate this additional issue, in one embodiment, one or more of the following options could be adopted:
Option 1: Gaps smaller than a certain duration should be avoided by the UE, and should be filled out with additional transmissions (e.g., CP extension, reference signal, data signals or any other option possibly including dummy/garbage transmissions) by the UE to form a contiguous transmission. For example, 1 and 2 symbol gaps for 60 kHz SCS and 1 symbol gap for 30 kHz SCS are not allowed, and always filled by the UE.
Option 2: Gaps smaller than a certain duration are not allowed and a UE should drop the follow up transmission. For example, 1 and 2 symbol gaps for 60 kHz SCS and 1 symbol gap for 30 kHz SCS are not allowed.
Option 3: Gap defined by the ETSI BRAN are adjusted by 10 us (or 5 us), and in particular one or more of the following could be adopted:
   no LBT could be extended to 16+10 us or 16+5 us (where the OFF/ON transient time could be taking care by implementation and by performing 4 us measurement at the head of the 9 us observation window), which means that no LBT for 1 symbol gap for 60 KHz SCS.
   16 us LBT is applied if gap is larger than 16+10 us (or 16+5 us) and less than 25+10 us (or 25+5 us)
   25 us LBT is applied if gap is larger than 25+10 us (or 25+5 us)
Option 4: Transient period is absorbed inside the start time interval of transmission and/or transient period is absorbed inside end time interval of transmission.
   In this case, the small gap equal to duration of LBT window can be supported
   UEs receiving transmissions may be allowed to skip processing of symbols affected by transient periods
Option 5: Transient period is reduced to 5 us (e.g., new requirement is imposed on transient period)
Option 6: The RAN4 mask is modified so that to capture the transient period within the SL transmission so no transmission will spill out, and potentially overlap within an LBT window.
Option 7: The position of the measurement windows are fixed to specific instance of time within the measurement window. For instance,
   for type 2B LBT, the 1 us measurement window is performed in the last 3 us of the first 7 us observation window, and/or the 4 us measurement window is performed in the first 4 us of the last 9 us observation window.
   For a 9 us observation time used for semi-static channel access mode, the 4 us sensing window is performed in the first or the last 4 us of the observation time.

### Frequency Interlaced Physical Structure

The regulations on power spectral density (PSD) limitation of 10 dBm/MHz by ETSI, and MIIT and 11 dBm/MHz by FCC as well as minimum percentage of occupied channel bandwidth (OCB) 80%-100% (see ETSI EN 301 893) implies the need to either use bandwidth extension at the expense of spectrum efficiency or to support interlaced channel structure which improves coverage with maximum spectrum efficiency.

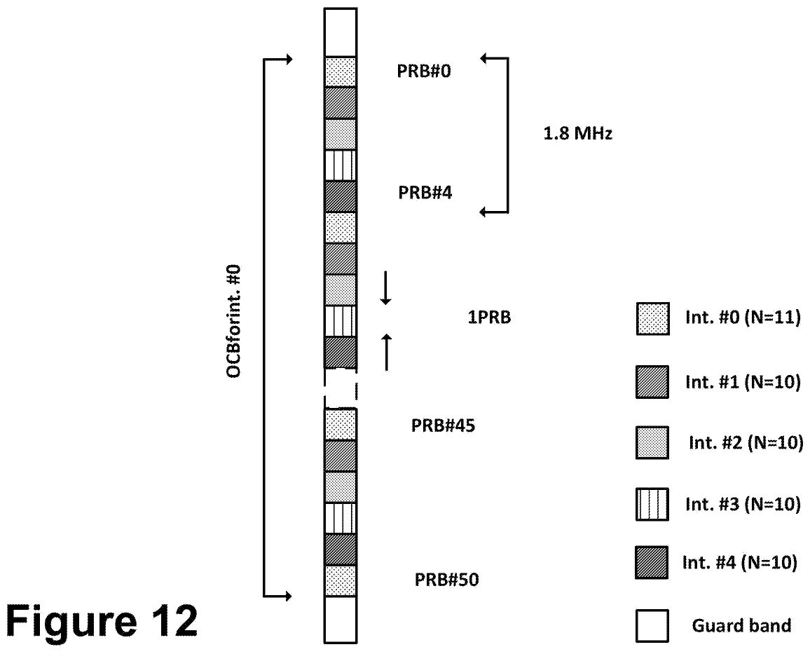

In Rel.16 NR-U uplink, the interlaced waveform was introduced and supported for both PUCCH and PUSCH transmissions. The frequency domain allocation for PUCCH and PUSCH is controlled by the higher layer parameter useInterlacePUCCH-PUSCH. As an example how different RBs are interlaces in 30 kHz subcarrier spacing (SCS) is illustrate in FIG. 12.

When the use of a interlace PUCCH-PUSCH is configured, for 15 kHz and 30 kHz SCS the interlace is formed based on the following table, where M is the number of interlaces per carrier and N is the number of RBs per interlace:

| SCS (kHz) | NRB (for 20 MHz) | M | N |
|---|---|---|---|
| 15 | 106 | 10 | 10/11 |
| 30 | 51 | 5 | 10/11 |

As for 60 kHz SCS or higher, no interlace is supported.

In this context, there are several specific challenges to enable NR-U SL. Embodiments herein provide techniques to enable an interlaced structure for the physical layer channels of the SL. The interlaced structure may be a general solution that may be applicable to any physical channel, such as physical sidelink shared channel (PSSCH), physical sidelink control channel (PSCCH), physical sidelink feedback channel (PSFCH), sidelink synchronization signal block (S-SSB), and/or physical sidelink broadcast channel (PSBCH).

For SL communication, support of interlaced structure can be considered for several UL physical channels, such as PSCCH/PSSCH/PSFCH/S-SSB and PSBCH. However, note that even in SL Rel. 16/17 design when a UE transmits feedback for multiple SL transmissions, the PSFCH transmission can already be scattered over the SL resource pool bandwidth. When considering an interlaces structure for SL, the following solutions may be considered:
Interleaving solutions that are based on interleaving single RBs. The Rel. 16 NR-U solution is an example of this category.
Interleaving solutions that are based on interleaving a group of RBs. Compare to single RB solutions these have the advantage of being more robust regarding a frequency offset across different UEs transmitting at the same time.
Interleaving solutions that are based on interleaving sub-carriers. Note that interleaving groups of sub-carriers can be considered the same as interleaving RBs or groups of RBs.

All interleaving solutions partition the number of available frequency resource into M parts. As the concept of sub-channel was introduced for SL, one of these parts can be view as a sub-channel. Thus, in the description of various embodiments herein, a sub-channel may refer to a set of frequency resources in general and not in the NR SL definition of several adjacent RBs. Note that for some of the options, it may be assumed that the NR SL resource pool configuration is extended to accommodate the additional information required for the NR-U SL operation.

### Single RB Interleaving

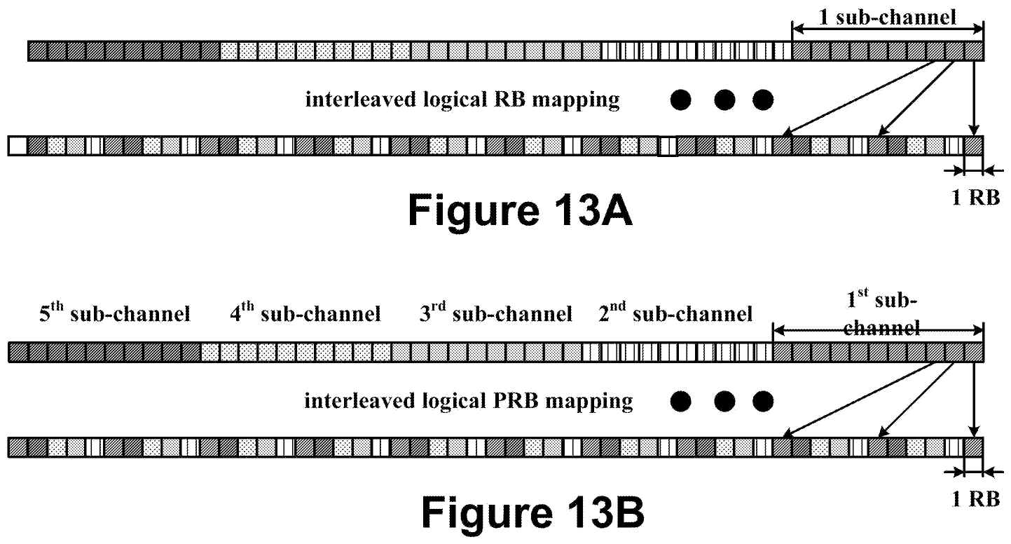

For the single RB solutions, a compromise between the NR SL and the NR-U solutions may be taken. In this matter, in one embodiment, one of the following options may be used:
Option 1: In this option the per resource pool configured number of K RBs is divided into M sub-channels each comprising of N RBs. Note that in the same fashion as in NR SL the K-M*N RBs remaining are not used for transmission. The N logical RBs of each sub-channel are mapped to physical RBs in an interleaved fashion. This means that the resource pool is configured in the same way as for Rel.16 NR SL, but with an additional RRC bit signaling usage of interleaved sub-channel logical to physical RB mapping. An example is illustrated in FIG. 13A). In one example, M is configurable or is fixed and equivalent to 10 for 15 kHz and 5 for 30 kHz.
Option 2: In this option the configuration of the resource pool is changed. In this case, one additional field to indicate an interleaved mapping needs to be introduced. Based on this field either the Rel. 16 NR SL field indicating the number of sub-channels needs to be reinterpreted or a new field for the number of interleaved frequency parts (also called sub-channels) needs to be introduced. The current Rel. 16 field indicating the number of RBs per sub-channel is redundant in this case, thus it can be re-interpreted. Based on this signaling the number of K available RBs is divided into M sub-channels. Note that in this case in contrast to the Rel.16 NR SL these sub-channels can have a different sized as some will have the size of └K/M┘ and some ┌K/M┐. The reminder RBs can be mapped to any of the sub-channels. An example is illustrated in FIG. 13B). In one example, M is configurable or is fixed and equivalent to 10 for 15 kHz and 5 for 30 kHz. Notice that by choosing M=10 and M=5 for 15 kHz and 30 kHz SCS, respectively, this mimics exactly the interlaced structure defined in NR-U, where some of the interlaces will be formed by K=10 PRBs and some by K=11 PRBs in same manner as Rel. 16 NR-U.

In one embodiment, regardless of whether option 1 or option 2 is supported a UE may be configured to transmit over one or more interlaces.

In one embodiment, the interlaced structure provided by the embodiments above may apply to one or more of the following physical channels:
PSCCH;
PSSCH;
PSFCH;
PSBCH;
S-SSB.

In one embodiment, for a PSCCH and PSSCH transmission, one sub-channel for PSSCH equals to N RB-based interlace across all RB set within the resource pool, where N is fixed (e.g., N=1) or N may be (pre-) configured.

### Group RB Interleaving

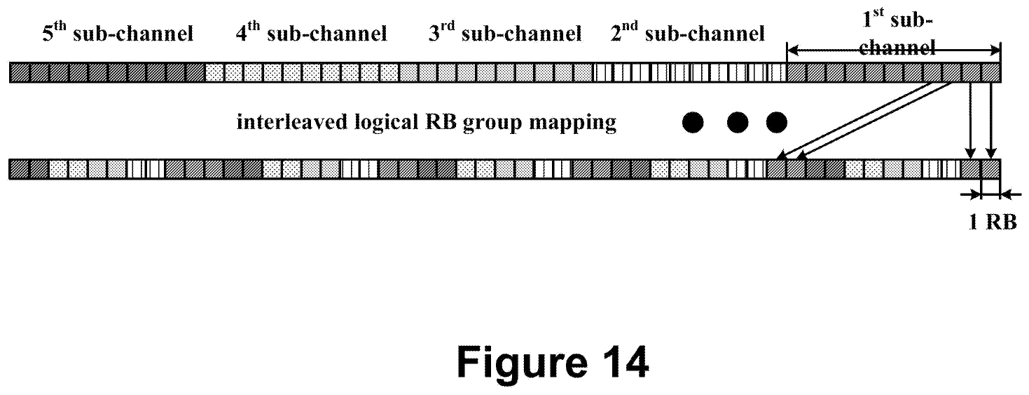

From the perspective of a receiver, it cannot always be guaranteed that the frequency synchronization of different UEs is perfect. For interleaved transmission this means that sub-carriers (SCs) at the edge of a group of SCs will experience inter-carrier interference (ICI) as the SCs from other UEs will not be fully orthogonal. Dependent on how large the expected frequency offset between different UEs is expected to be, this can motivate using a larger group of SCs than one RB for each UE. This also has the benefit of improved channel estimation as in this case it can be performed considering all RS in the group instead of only a single RB. As in the case of single RB interleave it is possible to either include the reminder RBs or do not consider them in the transmission. In this matter, in one embodiment, one of the following options may be used:
Option 1: After all available PBs are distributed to M sub-channels all additional RBs remaining are not used. The N RBs per sub-channel are afterwards divided into L RB groups. The RB groups of each sub-channel are than mapped to interleaved RB groups. Not that dependent on the number of RBs not every group does necessarily have the same size. The signaling for the resource pool configuration would consist of an additional PRG group size field. Also, a mapping rule for the groups need to be established. In one example, M, N, and L are configurable or can be fixed.
Option 2: In the second case all RBs are used. This means in contrast to option 1 the reminder RBs are added to the first (last or any other mapping) sub-channels. Again, the RBs in each sub-channel are divided into L RB groups. As shown in the example in FIG. 14. Note that also in this case the RB groups within a sub-channel do not necessarily have the same size. The resource pool signaling would be the same as for option 2 of the single RB interleaving case only adding an additional field for either the number of RB groups per sub-channel or the minimum number of RBs per RB group. In one example, M, N, and L are configurable or can be fixed.

In one embodiment, regardless of whether option 1 or option 2 is supported a UE may be configured to transmit over one or more interlaces.

In one embodiment, the interlaced structure provided by the embodiments above may apply to one or more of the following physical channels:
PSCCH;
PSSCH;
PSFCH;
PSBCH;
S-SSB.

### Sub-Carrier Based Interleaving

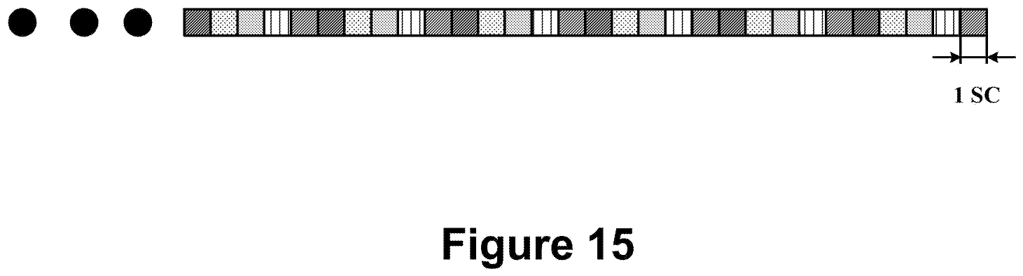

The third interleaving category is interleaving single sub-carriers. Note that groups of sub-carriers are not separately treated as this would be like the case of treating a group of SCs as an RB (potentially with a different size). The signaling in this case would also only consist of one additional information field that that is indicating that sub-carrier based interleaving is used. As shown in FIG. 15 a comb-x SC structure can be used. In the case of the illustrated example 5 different frequency resource are available.

In one embodiment, regardless of whether option 1 or option 2 is supported a UE may be configured to transmit over one or more interlaces.

In one embodiment, the interlaced structure provided by the embodiments above may apply to one or more of the following physical channels:
PSCCH;
PSSCH;
PSFCH;
PSBCH;
S-SSB.

### Configuration Parameters

In one embodiment, the interlaced structure may be enabled or disabled based on regional compliance, and cell-specific higher layer parameter may be introduced to enable the interlaced physical structure, and in this matter one of the following options could be adopted:
Option 1: a new RRC parameter (e.g., useInterlacePSCCH-PSSCH or useInterlacePSCCH-PSSCH-PSFCH) may be defined to enable and disable this waveform based on whether this may or may not be required by regional requirements for SL in unlicensed spectrum.
Option 2: the same RRC parameter defined in Rel.16 (e.g., useInterlacePUCCH-PUSCH) could be used, since this is simply an indication that the interlace is needed because of regional compliance.

In a separate option, it is possible to configure these as part of the resource pool configuration. In fact, as discussed above when listing the interlacing options for some of these options additional signaling fields are required.

Note that the enabling of the interlaced structure does make an interlaced structure also mandatory to be used for a transmission of the physical channel for which this is applied. Other options include that the interlaced structure is dependent on other system conditions, such as one or more of:
COT sharing
System load
LBT status
Unicast/Groupcast connection status
Network configuration

As an example, the interlaced structure may be used by a UE initiating a COT, but may not be required within a shared COT.

Notice that some of the options/embodiments provided above are not mutually exclusive but can be jointly adopted.

### Indication of the Interlaced Mapping

Embodiments herein may further relate to the indication of the interlaced mapping. In Rel. 16 NR-U, X bits from the FDRA field (either DCI or RRC) are used to indicate the interlace or interlaces that a UE should use at a given time for an PUSCH or PUCCH transmission, where:
X=5 bits are used for 30 kHz SCS, where the 5 bits form a bitmap for 5 interlaces;
X=6 bits are used for 15 kHz SCS, where the interlace indication is based on RIV based approach for 10 interlaces, where:
   RIV values 0 . . . 54 indicate the starting interlace index and the number of consecutive interlace indices.
   RIV values 55 . . . 63 indicate the following interlace combinations:

| RIV | Interlace Indexes |
|---|---|
| 55 | 0, 5 |
| 56 | 0, 1, 5, 6 |
| 57 | 1, 6 |
| 58 | 1, 2, 3, 4, 6, 7, 8, 9 |
| 59 | 2, 7 |
| 60 | 2, 3, 4, 7, 8, 9 |
| 61 | 3, 8 |
| 62 | 4, 9 |
| 63 | Reserved |

Moving forward to Rel. 18 SL a few approaches could be used for properly indicating the set of interlaces to use via sl-TxPoolScheduling, and in one embodiment, one or more of the following options may be used:
Option 1: When the resource pool configuration parameter defined/used to indicate the need of interlaced waveform is configured, sl-SubchannelSize-r16 is discharged, sl-StartRB-Subchannel-r16 is reinterpreted to indicate the lowest or highest RB of a specific interlace, while sl-NumSubchannel-r16 could be reinterpreted to indicate the number of consecutives interlaces (in frequency domain) to be used.

In case additional interlaced signaling is required new fields may be introduced, and these fields may be one or more of the following:
Interlaces PRB group size;
Allowed frequency resource allocation per LBT type.
Option 2: When the resource pool configuration parameter defined/used to indicate the need of interlaced waveform is configured, additional dedicated parameters could be added within the SL-ResourcePool IE to specify the set of interlaces to be used. For instance one or more of the following could be introduced:
Indication of the lowest or highest PRB of a specific interlace or set of interlaces;
Number of consecutive PRBs;
Bitmap indicating the interlaces to be used.
Option 3: In the case that the use of the interlaced physical structure is optional or conditional on the system state. This means that potentially wideband, interlaced, and sub-channel-based channel access need to coexists. This means that a configuration for all channel access methods need to be present in the resource pool configuration. In this matter, there are two sub options that could be considered:
Option 3A: There is a separate configuration of the frequency resource for any combination of present frequency allocation methods.
Option 3B: The configuration is based on reinterpretation of the already present sub-channel-based resource pool configuration fields. Additional functionality for other frequency allocation methods are based on reinterpretation of these fields or addition of new fields.

In one embodiment, either the SL control indication (SCI) 1-x (either stage 1 or stage 2 or both) or DCI 3_x or both could be enhanced to carry additional information related to the interlace or interlaces that a UE may be using for transmission. In particular, in terms of FDRA signaling in SCI 1-x and DCI 3_x one or more of the following options could be considered:
Option 1: the concept of reusing FDRA field design from SCI 1-x in DCI 3_x can be reused. At the same time, the frequency offset for the initial transmission scheduled by DCI 3_x needs to be modified to accommodate the interlace resource allocation. In this case, the lowest index of the subchannel allocation of the initial transmission can be signaled as an interlace index from 0 to M−1.
Option 2: when the RRC parameter defined/used to indicate the need of interlaced waveform is configured, the FDRA field within DCI 3_x and SCI 1-x is reinterpreted and X bits are used as in Rel. 16 NR-U to indicate the interlace or set of interlaces to be used. In one option, if wideband operation is supported in SL, Y bits are additionally used to indicate which RB sets (corresponding to LBT BWs) are allocated to a UE, where Y is determined by the number of RB sets N contained in the BWP as follows:

$$Y = ⌈ {log}_{2} ( \frac{N ( N + 1 )}{2} ) ⌉ .$$

Option 2a: In one sub-option, within DCI 3_x the field “First transmission sub-channel index” is not carried or this field is refurbished for other usage, and a transmission is spanned over the overall configured interlace or set of interlaces.
Option 2b: In one sub-option, within DCI 3_x the field “First transmission sub-channel index” is carried, and it is used to signal the lowest index of the RB belonging to the selected set of interlaces over which the initial transmission may span.
Option 3: For SCI 1-x and DCI 3_x signaling the structure from Rel. 16 SL is kept. This implies that the PSCCH is present only in one sub-channel, as the starting sub-channel of the transmission needs to connect to the PSCCH location.
Option 4: To indicate the sub-channel used/reserved, the sub-channel index indicated is determined by the interlace index within an RB set and the RB set index within a resource pool. In this case the indexing follows the interlace index first, followed by the RB set index.
Option 5: To indicate the sub-channel used/reserved, a UE may indicate in an independent manner the interlace index or sub-channel index within an RB set and the RB set index within a resource pool.

In terms of UE capability, in one embodiment, one of the following options could be adopted and related considerations could be made:
Alt.1: interlace is mandatory for NR-U SL from both RX and TX perspective.
Alt.2: interlace is optional for NR-U SL from TX perspective, but it is mandatory from RX perspective.
Alt.3: Interlaces is option for NR-U SL from both TX and RX perspective.

In one embodiment, PRBs belonging to the intra-cell guard band of two adjacent RB sets can be used for SL transmissions. In one option, this is only restricted to the case when a UE may be able to succeed LBT on both RB sets and the UE performs simultaneous transmission on both.

In one embodiment, PRBs belonging to the intra-cell guard band of two adjacent RB sets are never used for SL transmissions.

Note that some of the options/embodiments provided above are not mutually exclusive but can be jointly adopted

### Systems and Implementations

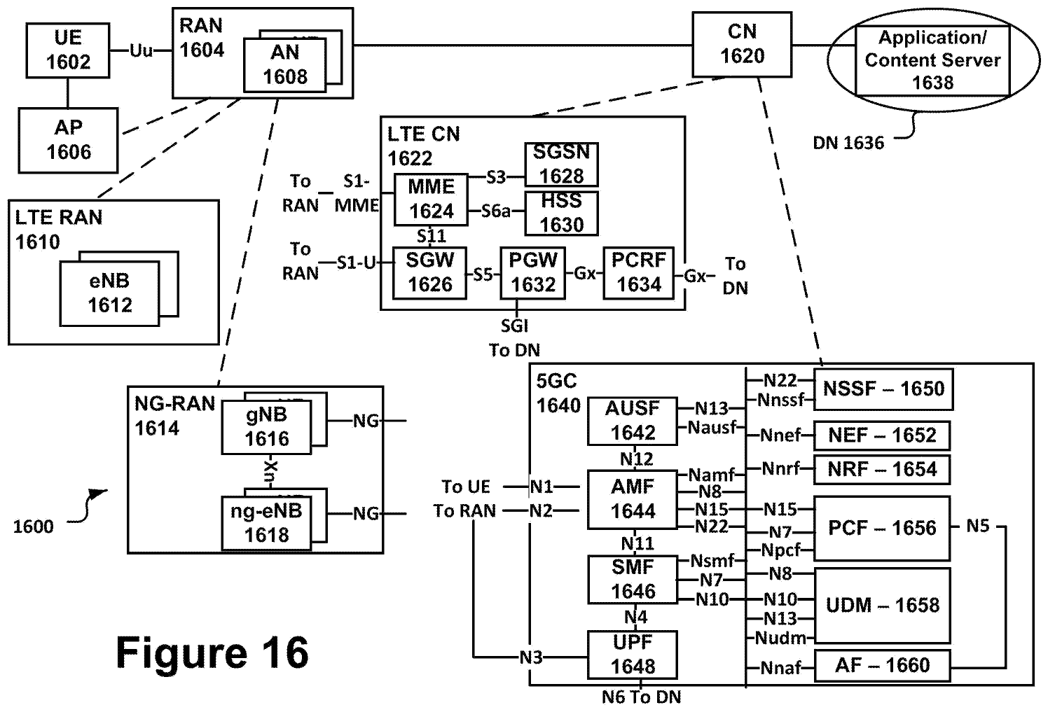

FIGS. 16-18 illustrate various systems, devices, and components that may implement aspects of disclosed embodiments.

FIG. 16 illustrates a network 1600 in accordance with various embodiments. The network 1600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1600 may include a UE 1602, which may include any mobile or non-mobile computing device designed to communicate with a RAN 1604 via an over-the-air connection. The UE 1602 may be communicatively coupled with the RAN 1604 by a Uu interface. The UE 1602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1602 may additionally communicate with an AP 1606 via an over-the-air connection. The AP 1606 may manage a WLAN connection, which may serve to offload some/all network traffic from the RAN 1604. The connection between the UE 1602 and the AP 1606 may be consistent with any IEEE 802.11 protocol, wherein the AP 1606 could be a wireless fidelity (Wi-Fi®) router. In some embodiments, the UE 1602, RAN 1604, and AP 1606 may utilize cellular-WLAN aggregation (for example, LWA/LWIP). Cellular-WLAN aggregation may involve the UE 1602 being configured by the RAN 1604 to utilize both cellular radio resources and WLAN resources.

The RAN 1604 may include one or more access nodes, for example, AN 1608. AN 1608 may terminate air-interface protocols for the UE 1602 by providing access stratum protocols including RRC, PDCP, RLC, MAC, and LI protocols. In this manner, the AN 1608 may enable data/voice connectivity between CN 1620 and the UE 1602. In some embodiments, the AN 1608 may be implemented in a discrete device or as one or more software entities running on server computers as part of, for example, a virtual network, which may be referred to as a CRAN or virtual baseband unit pool. The AN 1608 be referred to as a BS, gNB, RAN node, eNB, ng-eNB, NodeB, RSU, TRxP, TRP, etc. The AN 1608 may be a macrocell base station or a low power base station for providing femtocells, picocells or other like cells having smaller coverage areas, smaller user capacity, or higher bandwidth compared to macrocells.

In embodiments in which the RAN 1604 includes a plurality of ANs, they may be coupled with one another via an X2 interface (if the RAN 1604 is an LTE RAN) or an Xn interface (if the RAN 1604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1604 may each manage one or more cells, cell groups, component carriers, etc. to provide the UE 1602 with an air interface for network access. The UE 1602 may be simultaneously connected with a plurality of cells provided by the same or different ANs of the RAN 1604. For example, the UE 1602 and RAN 1604 may use carrier aggregation to allow the UE 1602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1602 or AN 1608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1604 may be an LTE RAN 1610 with eNBs, for example, eNB 1612. The LTE RAN 1610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1604 may be an NG-RAN 1614 with gNBs, for example, gNB 1616, or ng-eNBs, for example, ng-eNB 1618. The gNB 1616 may connect with 5G-enabled UEs using a 5G NR interface. The gNB 1616 may connect with a 5G core through an NG interface, which may include an N2 interface or an N3 interface. The ng-eNB 1618 may also connect with the 5G core through an NG interface, but may connect with a UE via an LTE air interface. The gNB 1616 and the ng-eNB 1618 may connect with each other over an Xn interface.

In some embodiments, the NG interface may be split into two parts, an NG user plane (NG-U) interface, which carries traffic data between the nodes of the NG-RAN 1614 and a UPF 1648 (e.g., N3 interface), and an NG control plane (NG-C) interface, which is a signaling interface between the nodes of the NG-RAN1614 and an AMF 1644 (e.g., N2 interface).

The NG-RAN 1614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1602 can be configured with multiple BWPs where each BWP configuration has a different SCS. When a BWP change is indicated to the UE 1602, the SCS of the transmission is changed as well. Another use case example of BWP is related to power saving. In particular, multiple BWPs can be configured for the UE 1602 with different amount of frequency resources (for example, PRBs) to support data transmission under different traffic loading scenarios. A BWP containing a smaller number of PRBs can be used for data transmission with small traffic load while allowing power saving at the UE 1602 and in some cases at the gNB 1616. A BWP containing a larger number of PRBs can be used for scenarios with higher traffic load.

The RAN 1604 is communicatively coupled to CN 1620 that includes network elements to provide various functions to support data and telecommunications services to customers/subscribers (for example, users of UE 1602). The components of the CN 1620 may be implemented in one physical node or separate physical nodes. In some embodiments, NFV may be utilized to virtualize any or all of the functions provided by the network elements of the CN 1620 onto physical compute/storage resources in servers, switches, etc. A logical instantiation of the CN 1620 may be referred to as a network slice, and a logical instantiation of a portion of the CN 1620 may be referred to as a network sub-slice.

In some embodiments, the CN 1620 may be an LTE CN 1622, which may also be referred to as an EPC. The LTE CN 1622 may include MME 1624, SGW 1626, SGSN 1628, HSS 1630, PGW 1632, and PCRF 1634 coupled with one another over interfaces (or “reference points”) as shown. Functions of the elements of the LTE CN 1622 may be briefly introduced as follows.

The MME 1624 may implement mobility management functions to track a current location of the UE 1602 to facilitate paging, bearer activation/deactivation, handovers, gateway selection, authentication, etc.

The SGW 1626 may terminate an SI interface toward the RAN and route data packets between the RAN and the LTE CN 1622. The SGW 1626 may be a local mobility anchor point for inter-RAN node handovers and also may provide an anchor for inter-3GPP mobility. Other responsibilities may include lawful intercept, charging, and some policy enforcement.

The SGSN 1628 may track a location of the UE 1602 and perform security functions and access control. In addition, the SGSN 1628 may perform inter-EPC node signaling for mobility between different RAT networks; PDN and S-GW selection as specified by MME 1624; MME selection for handovers; etc. The S3 reference point between the MME 1624 and the SGSN 1628 may enable user and bearer information exchange for inter-3GPP access network mobility in idle/active states.

The HSS 1630 may include a database for network users, including subscription-related information to support the network entities' handling of communication sessions. The HSS 1630 can provide support for routing/roaming, authentication, authorization, naming/addressing resolution, location dependencies, etc. An S6a reference point between the HSS 1630 and the MME 1624 may enable transfer of subscription and authentication data for authenticating/authorizing user access to the LTE CN 1620.

The PGW 1632 may terminate an SGi interface toward a data network (DN) 1636 that may include an application/content server 1638. The PGW 1632 may route data packets between the LTE CN 1622 and the data network 1636. The PGW 1632 may be coupled with the SGW 1626 by an S5 reference point to facilitate user plane tunneling and tunnel management. The PGW 1632 may further include a node for policy enforcement and charging data collection (for example, PCEF). Additionally, the SGi reference point between the PGW 1632 and the data network 16 36 may be an operator external public, a private PDN, or an intra-operator packet data network, for example, for provision of IMS services. The PGW 1632 may be coupled with a PCRF 1634 via a Gx reference point.

The PCRF 1634 is the policy and charging control element of the LTE CN 1622. The PCRF 1634 may be communicatively coupled to the app/content server 1638 to determine appropriate QoS and charging parameters for service flows. The PCRF 1632 may provision associated rules into a PCEF (via Gx reference point) with appropriate TFT and QCI.

In some embodiments, the CN 1620 may be a 5GC 1640. The 5GC 1640 may include an AUSF 1642, AMF 1644, SMF 1646, UPF 1648, NSSF 1650, NEF 1652, NRF 1654, PCF 1656, UDM 1658, and AF 1660 coupled with one another over interfaces (or “reference points”) as shown. Functions of the elements of the 5GC 1640 may be briefly introduced as follows.

The AUSF 1642 may store data for authentication of UE 1602 and handle authentication-related functionality. The AUSF 1642 may facilitate a common authentication framework for various access types. In addition to communicating with other elements of the 5GC 1640 over reference points as shown, the AUSF 1642 may exhibit an Nausf service-based interface.

The AMF 1644 may allow other functions of the 5GC 1640 to communicate with the UE 1602 and the RAN 1604 and to subscribe to notifications about mobility events with respect to the UE 1602. The AMF 1644 may be responsible for registration management (for example, for registering UE 1602), connection management, reachability management, mobility management, lawful interception of AMF-related events, and access authentication and authorization. The AMF 1644 may provide transport for SM messages between the UE 1602 and the SMF 1646, and act as a transparent proxy for routing SM messages. AMF 1644 may also provide transport for SMS messages between UE 1602 and an SMSF. AMF 1644 may interact with the AUSF 1642 and the UE 1602 to perform various security anchor and context management functions. Furthermore, AMF 1644 may be a termination point of a RAN CP interface, which may include or be an N2 reference point between the RAN 1604 and the AMF 1644; and the AMF 1644 may be a termination point of NAS (N1) signaling, and perform NAS ciphering and integrity protection. AMF 1644 may also support NAS signaling with the UE 1602 over an N3 IWF interface.

The SMF 1646 may be responsible for SM (for example, session establishment, tunnel management between UPF 1648 and AN 1608); UE IP address allocation and management (including optional authorization); selection and control of UP function; configuring traffic steering at UPF 1648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1644 over N2 to AN 1608; and determining SSC mode of a session. SM may refer to management of a PDU session, and a PDU session or “session” may refer to a PDU connectivity service that provides or enables the exchange of PDUs between the UE 1602 and the data network 1636.

The UPF 1648 may act as an anchor point for intra-RAT and inter-RAT mobility, an external PDU session point of interconnect to data network 1636, and a branching point to support multi-homed PDU session. The UPF 1648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1648 may include an uplink classifier to support routing traffic flows to a data network.

The NSSF 1650 may select a set of network slice instances serving the UE 1602. The NSSF 1650 may also determine allowed NSSAI and the mapping to the subscribed S-NSSAIs, if needed. The NSSF 1650 may also determine the AMF set to be used to serve the UE 1602, or a list of candidate AMFs based on a suitable configuration and possibly by querying the NRF 1654. The selection of a set of network slice instances for the UE 1602 may be triggered by the AMF 1644 with which the UE 1602 is registered by interacting with the NSSF 1650, which may lead to a change of AMF. The NSSF 1650 may interact with the AMF 1644 via an N22 reference point; and may communicate with another NSSF in a visited network via an N31 reference point (not shown). Additionally, the NSSF 1650 may exhibit an Nnssf service-based interface.

The NEF 1652 may securely expose services and capabilities provided by 3GPP network functions for third party, internal exposure/re-exposure, AFs (e.g., AF 1660), edge computing or fog computing systems, etc. In such embodiments, the NEF 1652 may authenticate, authorize, or throttle the AFs. NEF 1652 may also translate information exchanged with the AF 1660 and information exchanged with internal network functions. For example, the NEF 1652 may translate between an AF-Service-Identifier and an internal 5GC information. NEF 1652 may also receive information from other NFs based on exposed capabilities of other NFs. This information may be stored at the NEF 1652 as structured data, or at a data storage NF using standardized interfaces. The stored information can then be re-exposed by the NEF 1652 to other NFs and AFs, or used for other purposes such as analytics. Additionally, the NEF 1652 may exhibit an Nnef service-based interface.

The NRF 1654 may support service discovery functions, receive NF discovery requests from NF instances, and provide the information of the discovered NF instances to the NF instances. NRF 1654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1654 may exhibit the Nnrf service-based interface.

The PCF 1656 may provide policy rules to control plane functions to enforce them, and may also support unified policy framework to govern network behavior. The PCF 1656 may also implement a front end to access subscription information relevant for policy decisions in a UDR of the UDM 1658. In addition to communicating with functions over reference points as shown, the PCF 1656 exhibit an Npcf service-based interface.

The UDM 1658 may handle subscription-related information to support the network entities' handling of communication sessions, and may store subscription data of UE 1602. For example, subscription data may be communicated via an N8 reference point between the UDM 1658 and the AMF 1644. The UDM 1658 may include two parts, an application front end and a UDR. The UDR may store subscription data and policy data for the UDM 1658 and the PCF 1656, and/or structured data for exposure and application data (including PFDs for application detection, application request information for multiple UEs 1602) for the NEF 1652. The Nudr service-based interface may be exhibited by the UDR 221 to allow the UDM 1658, PCF 1656, and NEF 1652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1658 may exhibit the Nudm service-based interface.

The AF 1660 may provide application influence on traffic routing, provide access to NEF, and interact with the policy framework for policy control.

In some embodiments, the 5GC 1640 may enable edge computing by selecting operator/3rd party services to be geographically close to a point that the UE 1602 is attached to the network. This may reduce latency and load on the network. To provide edge-computing implementations, the 5GC 1640 may select a UPF 1648 close to the UE 1602 and execute traffic steering from the UPF 1648 to data network 1636 via the N6 interface. This may be based on the UE subscription data, UE location, and information provided by the AF 1660. In this way, the AF 1660 may influence UPF (re) selection and traffic routing. Based on operator deployment, when AF 1660 is considered to be a trusted entity, the network operator may permit AF 1660 to interact directly with relevant NFs. Additionally, the AF 1660 may exhibit an Naf service-based interface.

The data network 1636 may represent various network operator services, Internet access, or third party services that may be provided by one or more servers including, for example, application/content server 1638.

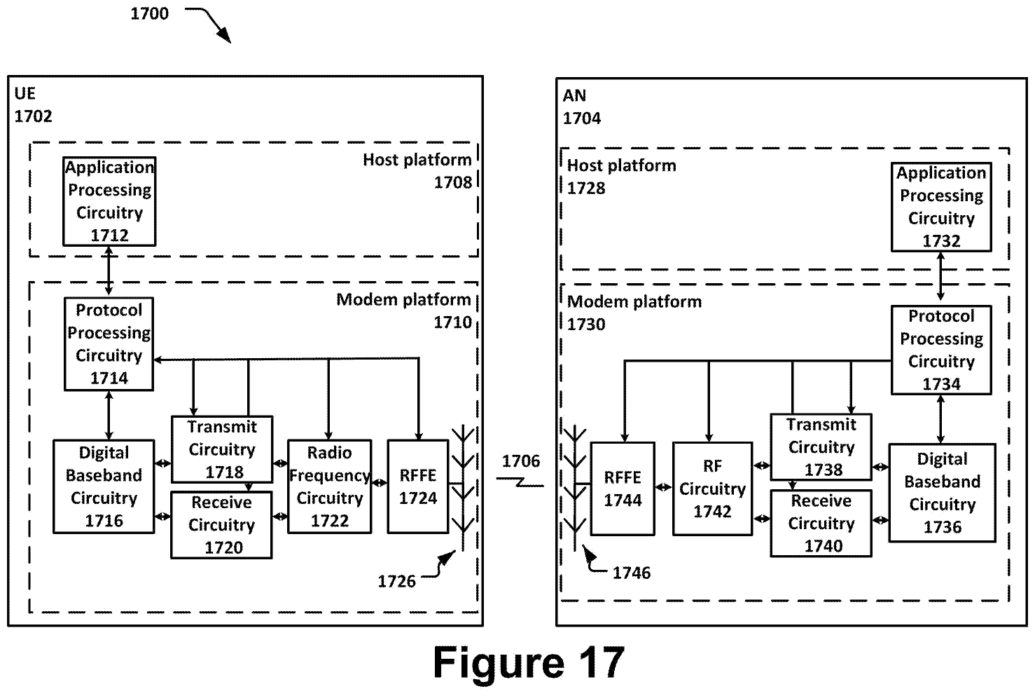

FIG. 17 schematically illustrates a wireless network 1700 in accordance with various embodiments. The wireless network 1700 may include a UE 1702 in wireless communication with an AN 1704. The UE 1702 and AN 1704 may be similar to, and substantially interchangeable with, like-named components described elsewhere herein.

The UE 1702 may be communicatively coupled with the AN 1704 via connection 1706. The connection 1706 is illustrated as an air interface to enable communicative coupling, and can be consistent with cellular communications protocols such as an LTE protocol or a 5G NR protocol operating at mm Wave or sub-6 GHZ frequencies.

The UE 1702 may include a host platform 1708 coupled with a modem platform 1710. The host platform 1708 may include application processing circuitry 1712, which may be coupled with protocol processing circuitry 1714 of the modem platform 1710. The application processing circuitry 1712 may run various applications for the UE 1702 that source/sink application data. The application processing circuitry 1712 may further implement one or more layer operations to transmit/receive application data to/from a data network. These layer operations may include transport (for example UDP) and Internet (for example, IP) operations

The protocol processing circuitry 1714 may implement one or more of layer operations to facilitate transmission or reception of data over the connection 1706. The layer operations implemented by the protocol processing circuitry 1714 may include, for example, MAC, RLC, PDCP, RRC and NAS operations.

The modem platform 1710 may further include digital baseband circuitry 1716 that may implement one or more layer operations that are “below” layer operations performed by the protocol processing circuitry 1714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1710 may further include transmit circuitry 1718, receive circuitry 1720, RF circuitry 1722, and RF front end (RFFE) 1724, which may include or connect to one or more antenna panels 1726. Briefly, the transmit circuitry 1718 may include a digital-to-analog converter, mixer, intermediate frequency (IF) components, etc.; the receive circuitry 1720 may include an analog-to-digital converter, mixer, IF components, etc.; the RF circuitry 1722 may include a low-noise amplifier, a power amplifier, power tracking components, etc.; RFFE 1724 may include filters (for example, surface/bulk acoustic wave filters), switches, antenna tuners, beamforming components (for example, phase-array antenna components), etc. The selection and arrangement of the components of the transmit circuitry 1718, receive circuitry 1720, RF circuitry 1722, RFFE 1724, and antenna panels 1726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1714 may include one or more instances of control circuitry (not shown) to provide control functions for the transmit/receive components.

A UE reception may be established by and via the antenna panels 1726, RFFE 1724, RF circuitry 1722, receive circuitry 1720, digital baseband circuitry 1716, and protocol processing circuitry 1714. In some embodiments, the antenna panels 1726 may receive a transmission from the AN 1704 by receive-beamforming signals received by a plurality of antennas/antenna elements of the one or more antenna panels 1726.

A UE transmission may be established by and via the protocol processing circuitry 1714, digital baseband circuitry 1716, transmit circuitry 1718, RF circuitry 1722, RFFE 1724, and antenna panels 1726. In some embodiments, the transmit components of the UE 1704 may apply a spatial filter to the data to be transmitted to form a transmit beam emitted by the antenna elements of the antenna panels 1726.

Similar to the UE 1702, the AN 1704 may include a host platform 1728 coupled with a modem platform 1730. The host platform 1728 may include application processing circuitry 1732 coupled with protocol processing circuitry 1734 of the modem platform 1730. The modem platform may further include digital baseband circuitry 1736, transmit circuitry 1738, receive circuitry 1740, RF circuitry 1742, RFFE circuitry 1744, and antenna panels 1746. The components of the AN 1704 may be similar to and substantially interchangeable with like-named components of the UE 1702. In addition to performing data transmission/reception as described above, the components of the AN 1708 may perform various logical functions that include, for example, RNC functions such as radio bearer management, uplink and downlink dynamic radio resource management, and data packet scheduling.

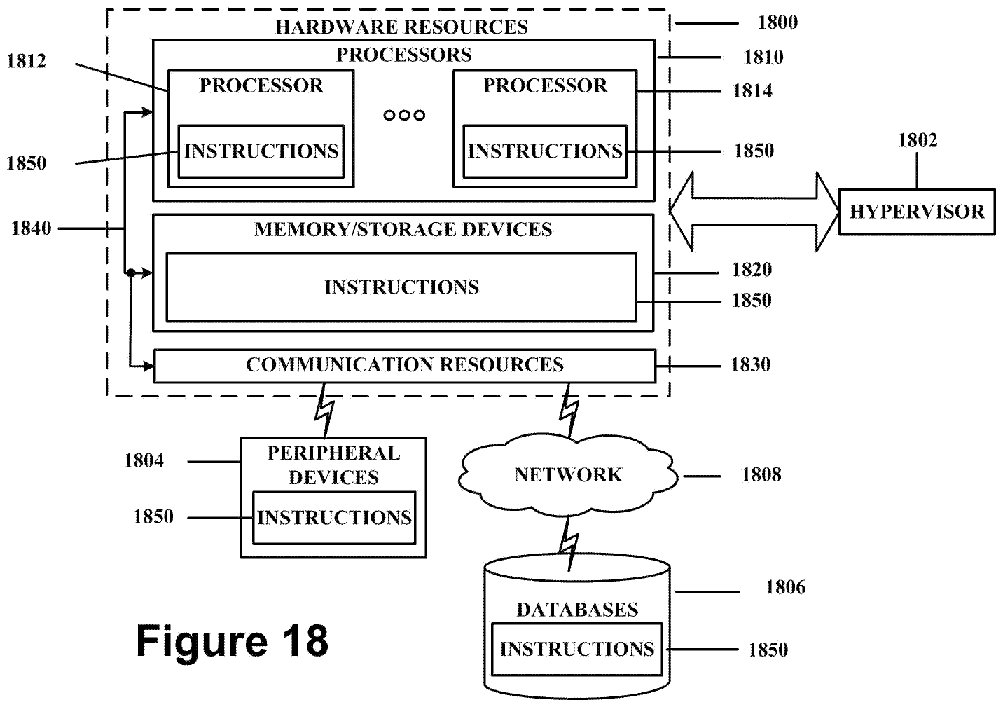

FIG. 18 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 18 shows a diagrammatic representation of hardware resources 1800 including one or more processors (or processor cores) 1810, one or more memory/storage devices 1820, and one or more communication resources 1830, each of which may be communicatively coupled via a bus 1840 or other interface circuitry. For embodiments where node virtualization (e.g., NFV) is utilized, a hypervisor 1802 may be executed to provide an execution environment for one or more network slices/sub-slices to utilize the hardware resources 1800.

The processors 1810 may include, for example, a processor 1812 and a processor 1814. The processors 1810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1820 may include main memory, disk storage, or any suitable combination thereof. The memory/storage devices 1820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1830 may include interconnection or network interface controllers, components, or other suitable devices to communicate with one or more peripheral devices 1804 or one or more databases 1806 or other network elements via a network 1808. For example, the communication resources 1830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1850 may comprise software, a program, an application, an applet, an app, or other executable code for causing at least any of the processors 1810 to perform any one or more of the methodologies discussed herein. The instructions 1850 may reside, completely or partially, within at least one of the processors 1810 (e.g., within the processor's cache memory), the memory/storage devices 1820, or any suitable combination thereof. Furthermore, any portion of the instructions 1850 may be transferred to the hardware resources 1800 from any combination of the peripheral devices 1804 or the databases 1806. Accordingly, the memory of processors 1810, the memory/storage devices 1820, the peripheral devices 1804, and the databases 1806 are examples of computer-readable and machine-readable media.

### Example Procedures

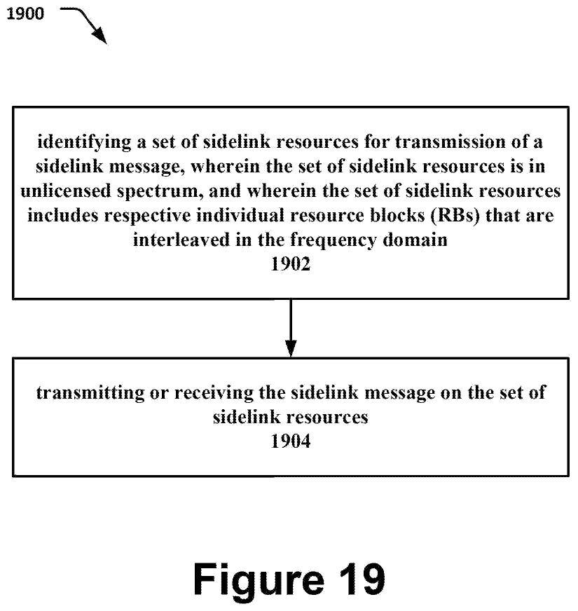

In some embodiments, the electronic device(s), network(s), system(s), chip(s) or component(s), or portions or implementations thereof, of FIGS. 16-18, or some other figure herein, may be configured to perform one or more processes, techniques, or methods as described herein, or portions thereof. One such process 1900 is depicted in FIG. 19. The process 1900 may be performed by a user equipment (UE), one or more elements of a UE, or an electronic device that includes a UE. At 1902, the process 1900 may include identifying a set of sidelink resources for transmission of a sidelink message, wherein the set of sidelink resources is in unlicensed spectrum, and wherein the set of sidelink resources includes respective individual resource blocks (RBs) that are interleaved in the frequency domain. At 1904, the process 1900 may further include transmitting or receiving the sidelink message on the set of sidelink resources.

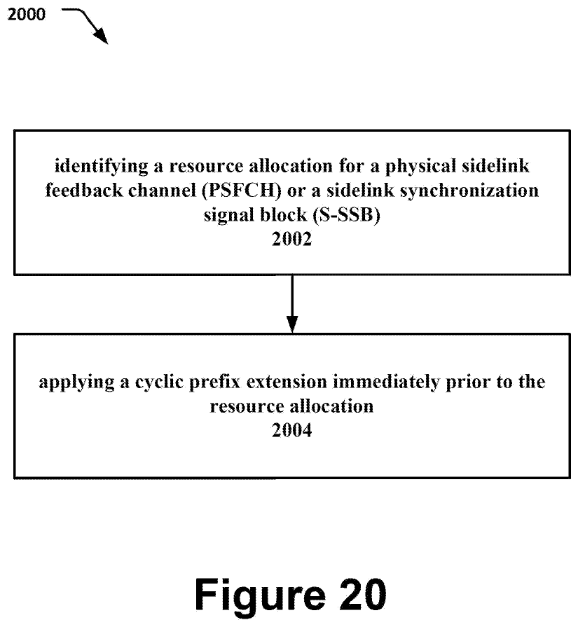

FIG. 20 illustrates another process 2000 in accordance with various embodiments. The process 2000 may be performed by a user equipment (UE), one or more elements of a UE, or an electronic device that includes a UE. At 2002, the process 2000 may include identifying a resource allocation for a physical sidelink feedback channel (PSFCH) or a sidelink synchronization signal block (S-SSB). At 2004, the process 2000 may further include applying a cyclic prefix extension immediately prior to the resource allocation.

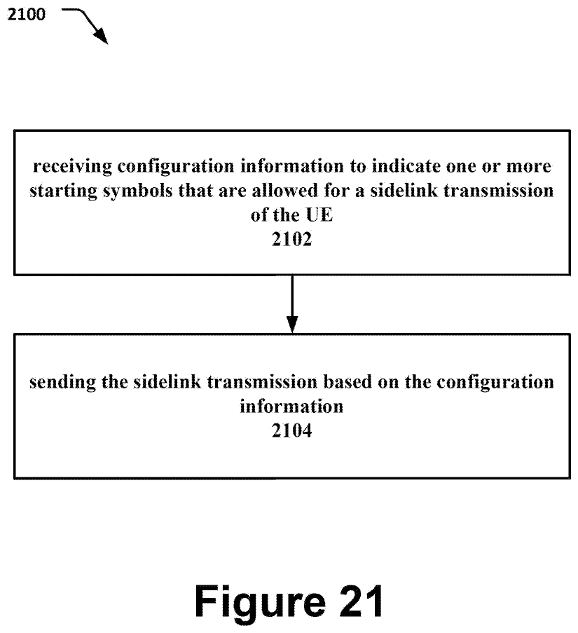

FIG. 21 illustrates another process 2100 in accordance with various embodiments. The process 2100 may be performed by a user equipment (UE), one or more elements of a UE, or an electronic device that includes a UE. At 2102, the process 2100 may include receiving configuration information to indicate one or more starting symbols that are allowed for a sidelink transmission of the UE. At 2104, the process 2100 may further include sending the sidelink transmission based on the configuration information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example A1 may include one or more non-transitory computer-readable media (NTCRM) having instructions, stored thereon, that when executed by one or more processors of a user equipment (UE) configure the UE to:

identify a set of sidelink resources for transmission of a sidelink message, wherein the set of sidelink resources is in unlicensed spectrum, and wherein the set of sidelink resources includes respective individual resource blocks (RBs) that are interleaved in the frequency domain; and transmit or receive the sidelink message on the set of sidelink resources.

Example A2 may include the one or more NTCRM of example A1, wherein a resource pool of K RBs is divided into M subchannels of N RBs, wherein the set of sidelink resources is one of the M subchannels, and wherein a remaining K−M*N RBs are not used for sidelink transmission.

Example A3 may include the one or more NTCRM of example A1, wherein the instructions when executed, are further to configure the UE to receive a radio resource control (RRC) message to indicate a resource pool for sidelink communication, wherein the RRC includes an indication that interleaved RB mapping is used for the resource pool, and wherein the set of sidelink resources is identified based on the indication.

Example A4 may include the one or more NTCRM of example A3, wherein the indication is a cell-specific indication based on a regional requirement for sidelink communication in unlicensed spectrum.

Example A5 may include the one or more NTCRM of example A3, wherein the instructions, when executed, further configure the UE to receive configuration information to indicate a set of interlaces of the resource pool that are included in the set of sidelink resources, wherein the configuration information includes one or more of:

an indication of a lowest or highest RB of the set of interlaces or of respective interlaces of the set of interlaces;

a number of consecutive interlaces in the frequency domain to be used;

a size of interlaced physical resource blocks (PRBs);

an allowed frequency resource allocation per listen-before-talk (LBT) type; or

a bitmap to indicate the set of interlaces.

Example A6 may include the one or more NTCRM of example A1, wherein the instructions, when executed, further configure the UE to receive a message to configure a number of interlaces into which a subchannel in the set of sidelink resources is mapped.

Example A7 may include the one or more NTCRM of any one of examples A1-A6, wherein the set of sidelink resources is a first set of sidelink resources, and wherein the instructions, when executed, further configure the UE to:

identify a second set of sidelink resources that includes RBs adjacent to respective RBs of the first set of sidelink resources; and

transmit or receive, simultaneously with the transmission or reception of the sidelink message on the first set of sidelink resources, the sidelink message or another sidelink message on the second set of sidelink resources and an intra-cell guard band between the first and second sets of sidelink resources.

Example A8 may include one or more non-transitory computer-readable media (NTCRM) having instructions, stored thereon, that when executed by one or more processors of a user equipment (UE) configure the UE to:

identify a resource allocation for a physical sidelink feedback channel (PSFCH) or a sidelink synchronization signal block (S-SSB); and

apply a cyclic prefix extension immediately prior to the resource allocation.

Example A9 may include the one or more NTCRM of example A8, wherein the cyclic prefix extension has a length of

$${T}_{symb , ( l - 1 ) mod 7 \cdot {2}^{μ}}^{μ} - Y$$

wherein l is a symbol in which the cyclic prefix extension is applied, μ is a value based on a subcarrier spacing, and Y is a time period.

Example A10 may include the one or more NTCRM of example A9, wherein Y is less than or equal to 16 microseconds.

Example A11 may include the one or more NTCRM of example A8, wherein the cyclic prefix extension is applied prior to the PSFCH or the S-SSB if a prior sidelink transmission of the UE or another UE is to end one symbol before a start of the PSFCH or the S-SSB.

Example A12 may include the one or more NTCRM of example A8, wherein the S-SSB is transmitted outside of a channel occupancy time of the UE, and wherein a listen-before-talk type 2A is used for the SSB if one or more of:

the S-SSB transmission is at most 1 millisecond long; or

a duty cycle of the S-SSB is at most 1/20 over an observation period.

Example A13 may include the one or more NTCRM of any one of examples A8-A12, wherein the instructions, when executed, are further to configure the UE to perform a listen-before-talk (LBT) procedure prior to transmission of the PSFCH, wherein the LBT procedure stops at a designated time that is the same for all UEs communicating on a same sidelink carrier.

Example A14 may include one or more non-transitory computer-readable media (NTCRM) having instructions, stored thereon, that when executed by one or more processors of a user equipment (UE) configure the UE to:

receive configuration information to indicate two starting symbols that are allowed for a sidelink transmission of the UE; and

send the sidelink transmission based on the configuration information.

Example A15 may include the one or more NTCRM of example A14, wherein the two starting symbols correspond to respective starting positions within a slot.

Example A16 may include the one or more NTCRM of example A14, wherein the two starting symbols correspond to any symbol within a pre-configured set of values.

Example A17 may include the one or more NTCRM of example A14, wherein the instructions, when executed, further configure the UE to apply a pre-configured cyclic prefix extension prior to the sidelink transmission.

Example A18 may include the one or more NTCRM of example A14, wherein the instructions, when executed, further configure the UE to perform a listen-before-talk procedure prior to the sidelink transmission.

Example A19 may include the one or more NTCRM of example A14, wherein the LBT procedure stops at a designated time that is the same for all UEs communicating on a same sidelink carrier.

Example A20 may include the one or more NTCRM of any one of examples A14-A19, wherein the sidelink transmission is a physical sidelink shared channel (PSSCH) or a physical sidelink control channel (PSCCH).

Example B1 may include the methods to adjust the TX/RX switching gap for a SL system operating in unlicensed spectrum to fulfil LBT requirements when within a SL the PSFCH is not carried;

Example B2 may include the methods to adjust the TX/RX switching gap for a SL system operating in unlicensed spectrum to fulfil LBT requirements when within a SL a PSFCH is carried;

Example B3 may include the methods to support a SL system operating in unlicensed spectrum and mitigate mutual interference across UEs when this operate in FDM mode;

Example B4 may include the methods to support a SL system operating in unlicensed spectrum and mitigate mutual interference across UEs when this operate in TDM mode;

Example B5 may include the methods to adapt the AGC for a UE in the case of LBT operation

Example B6 may include the methods to consider the ON/OFF transition of the transmitter for the LBT operation.

Example B7 includes a method to be performed by a user equipment (UE), one or more elements of a UE, or an electronic device that includes a UE, wherein the method comprises:

identifying that a switching guard period is greater than 16 μs;

shortening the switching guard period to be less than or equal to 16 μs; and

transmitting a sidelink (SL) transmission using the shortened switching guard period.

Example B8 includes the method of example B7 and/or some other example herein, wherein the switching guard period is a TX/RX or a RX/TX switching gap.

Example B9 includes the method of any of examples B7-B8, and/or some other example herein, wherein shortening the switching guard period includes shortening the switching guard period to be less than or equal to 13 μs.

Example B10 includes the method of any of examples B7-B9, and/or some other example herein, further comprising transmitting the SL transmission without the use of LBT.

Example B11 includes the method of any of examples B7-B10, and/or some other example herein, wherein shortening the switching guard period includes identifying resources on which to transmit the SL transmission that are not aligned with a symbol or slot boundary of the frame or subframe in which the SL transmission is to be transmitted.

Example B12 includes the method of any of examples B7-B11, and/or some other example herein, wherein the SL transmission is a physical SL feedback channel (PSFCH) transmission.

Example B13 includes the method of example B12, and/or some other example herein, further comprising adding, prior to transmission of the PSFCH transmission, a cyclic prefix extension with a length that is based on whether the UE transmitting PSFCH is able to operate as responding device within its own or another UE's COT.

Example C1 may include a method to meet channel occupancy regulatory requirements in order to enable a SL system to operate in unlicensed spectrum are provided.

Example C2 may include the method of example C1 or some other example herein, wherein single interleaving methods are introduced.

Example C3 may include the method of example C1 or some other example herein, wherein group interleaving methods are introduced.

Example C4 may include the method of example C1 or some other example herein, wherein sub-carrier based interleaving methods are introduced.

Example C5 may include the method of examples C1-C4 or some other example herein, wherein different options on how to configure the above methods are provided.

Example C6 may include a method of a UE, the method comprising:

determining a set of sidelink resources for transmission of a sidelink message, wherein the set of sidelink resources is interleaved in the time domain and/or frequency domain; and

transmitting the sidelink message on the set of sidelink resources.

Example C7 may include the method of example C6 or some other example herein, wherein the set of sidelink resources are in unlicensed spectrum.

Example C8 may include the method of example C6-C7 or some other example herein, wherein the set of sidelink resources are interleaved using single resource block interleaving.

Example C9 may include the method of example C6-C7 or some other example herein, wherein respective groups of multiple resource blocks are interleaved from one another in the set of sidelink resources.

Example C10 may include the method of example C6-C9 or some other example herein, wherein subcarriers of the set of sidelink resources are interleaved.

Example C11 may include the method of example C6-C10 or some other example herein, further comprising receiving an indicator to activate interleaving.

Example C12 may include the method of example C6-C11 or some other example herein, wherein the sidelink message is a PSCCH, PSSCH, PSFCH, PSBCH, and/or S-SSB.

Example Z01 may include an apparatus comprising means to perform one or more elements of a method described in or related to any of examples A1-A20, B1-B13, C1-C12, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A20, B1-B13, C1-C12, or any other method or process described herein.

Example Z03 may include an apparatus comprising logic, modules, or circuitry to perform one or more elements of a method described in or related to any of examples A1-A20, B1-B13, C1-C12, or any other method or process described herein.

Example Z04 may include a method, technique, or process as described in or related to any of examples A1-A20, B1-B13, C1-C12, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A20, B1-B13, C1-C12, or portions thereof.

Example Z06 may include a signal as described in or related to any of examples A1-A20, B1-B13, C1-C12, or portions or parts thereof.

Example Z07 may include a datagram, packet, frame, segment, protocol data unit (PDU), or message as described in or related to any of examples A1-A20, B1-B13, C1-C12, or portions or parts thereof, or otherwise described in the present disclosure.

Example Z08 may include a signal encoded with data as described in or related to any of examples A1-A20, B1-B13, C1-C12, or portions or parts thereof, or otherwise described in the present disclosure.

Example Z09 may include a signal encoded with a datagram, packet, frame, segment, protocol data unit (PDU), or message as described in or related to any of examples A1-A20, B1-B13, C1-C12, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A20, B1-B13, C1-C12, or portions thereof.

Example Z11 may include a computer program comprising instructions, wherein execution of the program by a processing element is to cause the processing element to carry out the method, techniques, or process as described in or related to any of examples A1-A20, B1-B13, C1-C12, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | |
|---|---|---|
| 5 | 3GPP | Third |
| | | Generation |
| | | Partnership |
| | | Project |
| | 4G | Fourth |
| | | Generation |
| | 5G | Fifth |
| | | Generation |
| 10 | 5GC | 5G Core network |
| | AC | Application |
| | | Client |
| 15 | ACR | Application |
| | | Context Relocation |
| | ACK | Acknowledgement |
| 20 | ACID | Application |
| | | Client Identification |
| | AF | Application |
| | | Function |
| 25 | AM | Acknowledged |
| | | Mode |
| | AMBR | Aggregate |
| | | Maximum Bit Rate |
| 30 | AMF | Access and |
| | | Mobility |
| | | Management |
| | | Function |
| | AN | Access |
| | | Network |
| 35 | ANR | Automatic |
| | | Neighbour Relation |
| | AOA | Angle of |
| | | Arrival |
| | AP | Application |
| | | Protocol, Antenna |
| 40 | | Port, Access Point |
| | API | Application |
| | | Programming Interface |
| | APN | Access Point Name |
| 45 | ARP | Allocation and |
| | | Retention Priority |
| | ARQ | Automatic |
| | | Repeat Request |
| | AS | Access Stratum |
| 50 | ASP | Application Service |
| | | Provider |
| 55 | ASN.1 | Abstract Syntax |
| | | Notation One |
| | AUSF | Authentication |
| | | Server Function |
| 60 | AWGN | Additive |
| | | White Gaussian Noise |
| | BAP | Backhaul |
| | | Adaptation Protocol |
| | BCH | Broadcast |
| | | Channel |
| 65 | BER | Bit Error Ratio |
| | BFD | Beam |
| | | Failure Detection |
| | BLER | Block Error |
| | | Rate |
| 70 | BPSK | Binary Phase |
| | | Shift Keying |
| | BRAS | Broadband |
| | | Remote Access |
| | | Server |
| 75 | BSS | Business |
| | | Support System |
| | BS | Base Station |
| | BSR | Buffer Status |
| | | Report |
| 80 | BW | Bandwidth |
| | BWP | Bandwidth Part |
| | C-RNTI | Cell Radio Network |
| | | Temporary |
| | | Identity |
| 85 | CA | Carrier |
| | | Aggregation, |
| | | Certification |
| | | Authority |
| 90 | CAPEX | CAPital |
| | | Expenditure |
| | CBD | Candidate |
| | | Beam Detection |
| 95 | CBRA | Contention |
| | | Based Random |
| | | Access |
| 100 | CC | Component |
| | | Carrier, Country |
| | | Code, Cryptographic |
| | | Checksum |
| | CCA | Clear Channel |
| | | Assessment |
| | CCE | Control |
| | | Channel Element |
| 105 | CCCH | Common |
| | | Control Channel |
| 5 | CE | Coverage |
| | | Enhancement |
| | CDM | Content |
| | | Delivery Network |
| | CDMA | Code- |
| | | Division Multiple |
| | | Access |
| 10 | CDR | Charging Data |
| | | Request |
| | CDR | Charging Data |
| | | Response |
| | CFRA | Contention Free |
| | | Random Access |
| 15 | CG | Cell Group |
| | CGF | Charging |
| | | Gateway Function |
| | CHF | Charging |
| | | Function |
| 20 | CI | Cell Identity |
| | CID | Cell-ID (e.g., |
| | | positioning method) |
| | CIM | Common |
| | | Information Model |
| 25 | CIR | Carrier to |
| | | Interference Ratio |
| | CK | Cipher Key |
| 30 | CM | Connection |
| | | Management, |
| | | Conditional |
| | | Mandatory |
| | CMAS | Commercial |
| | | Mobile Alert Service |
| | CMD | Command |
| 35 | CMS | Cloud |
| | | Management System |
| 40 | CO | Conditional |
| | | Optional |
| | COMP | Coordinated |
| | | Multi-Point |
| | CORESET | Control |
| | | Resource Set |
| | COTS | Commercial |
| | | Off-The-Shelf |
| 45 | CP | Control Plane, |
| | | Cyclic Prefix, |
| | | Connection |
| | | Point |
| 50 | CPD | Connection |
| | | Point Descriptor |
| | CPE | Customer |
| | | Premise |
| | | Equipment |
| 55 | CPICH | Common Pilot |
| | | Channel |
| | CQI | Channel |
| | | Quality Indicator |
| 60 | CPU | CSI processing |
| | | unit, Central |
| | | Processing Unit |
| | C/R | Command/Resp |
| | | onse field bit |
| 65 | CRAN | Cloud Radio |
| | | Access |
| | | Network, Cloud |
| | | RAN |
| | CRB | Common |
| | | Resource Block |
| 70 | CRC | Cyclic |
| | | Redundancy Check |
| 75 | CRI | Channel-State |
| | | Information |
| | | Resource |
| | | Indicator, CSI-RS |
| | | Resource |
| | | Indicator |
| | C-RNTI | Cell |
| | | RNTI |
| 80 | CS | Circuit |
| | | Switched |
| | CSCF | call |
| | | session control function |
| | CSAR | Cloud Service |
| 85 | | Archive |
| | CSI | Channel-State |
| | | Information |
| 90 | CSI-IM | CSI |
| | | Interference |
| | | Measurement |
| | CSI-RS | CSI |
| | | Reference Signal |
| 95 | CSI-RSRP | CSI |
| | | reference signal |
| | | received power |
| | CSI-RSRQ | CSI |
| | | reference signal |
| | | received quality |
| 100 | CSI-SINR | CSI |
| | | signal-to-noise and |
| | | interference |
| | | ratio |
| | CSMA | Carrier Sense |
| | | Multiple Access |
| 105 | CSMA/CA | CSMA |
| | | (GSM Evolution) |
| | | with collision |
| | | avoidance |
| 5 | CSS | Common |
| | | Search Space, |
| | | Cell-specific |
| | | Search Space |
| | CTF | Charging |
| | | Trigger Function |
| | CTS | Clear-to-Send |
| 10 | CW | Codeword |
| | CWS | Contention |
| | | Window Size |
| | D2D | Device-to-Device |
| 15 | DC | Dual |
| | | Connectivity, |
| | | Direct Current |
| 20 | DCI | Downlink |
| | | Control |
| | | Information |
| | DF | Deployment |
| | | Flavour |
| | DL | Downlink |
| 25 | DMTF | Distributed |
| | | Management Task |
| | | Force |
| | DPDK | Data Plane |
| | | Development Kit |
| 30 | DM-RS, DMRS | Demodulation |
| | | Reference Signal |
| | DN | Data network |
| | DNN | Data Network |
| | | Name |
| 35 | DNAI | Data Network |
| | | Access Identifier |
| 40 | DRB | Data Radio |
| | | Bearer |
| | DRS | Discovery |
| | | Reference Signal |
| | DRX | Discontinuous |
| | | Reception Signal |
| 45 | DSL | Domain |
| | | Specific Language. |
| | | Digital |
| | | Subscriber Line |
| | DSLAM | DSL Access |
| | | Multiplexer |
| 50 | DwPTS | Downlink Pilot |
| | | Time Slot |
| | E-LAN | Ethernet |
| | | Local Area Network |
| 55 | E2E | End-to-End |
| | EAS | Edge |
| | | Application Server |
| 60 | ECCA | extended clear |
| | | channel |
| | | assessment, |
| | | extended CCA |
| 65 | ECCE | Enhanced |
| | | Control Channel |
| | | Element, |
| | | Enhanced CCE |
| | ED | Energy |
| | | Detection |
| 70 | EDGE | Enhanced |
| | | Datarates |
| | | for GSM |
| | | Evolution |
| 75 | EAS | Edge |
| | | Application Server |
| | EASID | Edge |
| | | Application Server |
| | | Identification |
| | ECS | Edge |
| | | Configuration Server |
| 80 | ECSP | Edge |
| | | Computing Service |
| | | Provider |
| | EDN | Edge |
| | | Data Network |
| 85 | EEC | Edge |
| | | Enabler Client |
| | EECID | Edge |
| | | Enabler Client |
| | | Identification |
| | EES | Edge |
| | | Enabler Server |
| 90 | EESID | Edge |
| | | Enabler Server |
| | | Identification |
| 95 | EHE | Edge |
| | | Hosting Environment |
| | EGMF | Exposure |
| | | Governance |
| | | Management |
| | | Function |
| 100 | EGPRS | Enhanced |
| | | GPRS |
| | EIR | Equipment |
| | | Identity Register |
| 105 | eLAA | enhanced |
| | | Licensed Assisted |
| | | Access, enhanced LAA |
| 5 | EM | Element |
| | | Manager |
| | eMBB | Enhanced |
| | | Mobile |
| | | Broadband |
| 10 | EMS | Element |
| | | Management System |
| | eNB | evolved NodeB, |
| | E-UTRAN | Node B |
| 15 | EN-DC | E-UTRA-NR |
| | | Dual |
| | | Connectivity |
| | EPC | Evolved Packet |
| | | Core |
| 20 | EPDCCH | enhanced |
| | | PDCCH, enhanced |
| | | Physical |
| | | Downlink Control |
| | | Cannel |
| 25 | EPRE | Energy per |
| | | resource element |
| | EPS | Evolved Packet |
| | | System |
| 30 | EREG | enhanced REG, |
| | | enhanced resource |
| | | element groups |
| | ETSI | European |
| | | Telecommunications |
| | | Standards |
| | | Institute |
| 35 | ETWS | Earthquake and |
| | | Tsunami Warning |
| | | System |
| 40 | eUICC | embedded |
| | | UICC, embedded |
| | | Universal |
| | | Integrated Circuit |
| | | Card |
| | E-UTRA | Evolved UTRA |
| 45 | E-UTRAN | Evolved |
| | | UTRAN |
| | EV2X | Enhanced V2X |
| | F1AP | F1 Application |
| | | Protocol |
| 50 | F1-C | F1 Control |
| | | plane interface |
| | F1-U | F1 User plane |
| | | interface |
| 55 | FACCH | Fast |
| | | Associated Control |
| | | CHannel |
| 60 | FACCH/F | Fast |
| | | Associated Control |
| | | Channel/Full rate |
| | FACCH/H | Fast |
| | | Associated Control |
| | | Channel/Half |
| | | rate |
| 65 | FACH | Forward Access |
| | | Channel |
| | FAUSCH | Fast |
| | | Uplink Signalling |
| | | Channel |
| 70 | FB | Functional |
| | | Block |
| | FBI | Feedback |
| | | Information |
| 75 | FCC | Federal |
| | | Communications |
| | | Commission |
| | FCCH | Frequency |
| | | Correction CHannel |
| 80 | FDD | Frequency |
| | | Division Duplex |
| | FDM | Frequency |
| | | Division |
| | | Multiplex |
| 85 | FDMA | Frequency |
| | | Division Multiple |
| | | Access |
| | FE | Front End |
| | FEC | Forward Error |
| | | Correction |
| 90 | FFS | For Further |
| | | Study |
| | FFT | Fast Fourier |
| | | Transformation |
| 95 | feLAA | further |
| | | enhanced Licensed |
| | | Assisted Access, |
| | | further |
| | | enhanced LAA |
| | FN | Frame Number |
| 100 | FPGA | Field- |
| | | Programmable Gate |
| | | Array |
| | FR | Frequency |
| | | Range |
| 105 | FQDN | Fully Qualified Domain Name |
| 5 | G-RNTI | GERAN |
| | | Radio Network |
| | | Temporary |
| | | Identity |
| 10 | GERAN | GSM EDGE |
| | | RAN, GSM EDGE |
| | | Radio Access |
| | | Network |
| | GGSN | Gateway GPRS |
| | | Support Node |
| 15 | GLONASS | GLObal'naya |
| | | NAvigatsionnay |
| | | a Sputnikovaya |
| | | Sistema (Engl.: |
| | | Global Navigation |
| | | Satellite System) |
| 20 | gNB | Next |
| | | Generation NodeB |
| 25 | gNB-CU | gNB-centralized unit, |
| | | Next Generation NodeB |
| | | centralized unit |
| 30 | gNB-DU | gNB-distributed unit, |
| | | Next Generation |
| | | NodeB |
| | | distributed unit |
| 35 | GNSS | Global |
| | | Navigation Satellite |
| | | System |
| | GPRS | General Packet |
| | | Radio Service |
| 40 | GPSI | Generic |
| | | Public Subscription |
| | | Identifier |
| 45 | GSM | Global System |
| | | for Mobile |
| | | Communications, |
| | | Groupe Spécial |
| | | Mobile |
| 50 | GTP GPRS | Tunneling Protocol |
| | | GTP-UGPRS |
| | | Tunnelling Protocol |
| | | for User Plane |
| | GTS | Go To Sleep |
| | | Signal (related |
| | | to WUS) |
| 55 | GUMMEI | Globally |
| | | Unique MME |
| | | Identifier |
| | GUTI | Globally |
| | | Unique Temporary |
| 60 | UE | Identity |
| | HARQ | Hybrid ARQ, |
| | | Hybrid |
| | | Automatic |
| | | Repeat Request |
| 65 | HANDO | Handover |
| | HFN | HyperFrame |
| | | Number |
| | HHO | Hard Handover |
| 70 | HLR | Home Location |
| | | Register |
| | HO | Handover |
| 75 | HPLMN | Home |
| | | Public Land Mobile |
| | | Network |
| | HSDPA | High Speed Downlink |
| | | Packet Access |
| 80 | HSN | Hopping |
| | | Sequence Number |
| | HSPA | High Speed |
| | | Packet Access |
| | HSS | Home |
| | | Subscriber Server |
| 85 | HSUPA | High Speed |
| | | Uplink Packet |
| | | Access |
| | HTTP | Hyper Text |
| | | Transfer Protocol |
| 90 | HTTPS | Hyper Text Transfer |
| | | Protocol |
| | | Secure (https is |
| | | http/1.1 over |
| | | SSL, i.e. port 443) |
| 95 | I-Block | Information |
| | | Block |
| 100 | ICCID | Integrated |
| | | Circuit Card |
| | | Identification |
| | IAB | Integrated |
| | | Access and |
| | | Backhaul |
| 105 | ICIC | Inter-Cell |
| | | Interference |
| | | Coordination |
| | ID | Identity, |
| | | identifier |
| 5 | IDFT | Inverse Discrete |
| | | Fourier |
| | | Transform |
| | IE | Information |
| | | element |
| 10 | IBE | In-Band |
| | | Emission |
| | IEEE | Institute of |
| | | Electrical and |
| | | Electronics |
| | | Engineers |
| 15 | IEI | Information |
| | | Element |
| | | Identifier |
| 20 | IEIDL | Information |
| | | Element |
| | | Identifier Data |
| | | Length |
| | IETF | Internet |
| | | Engineering Task |
| | | Force |
| 25 | IF | Infrastructure |
| | IIOT | Industrial |
| | | Internet of Things |
| | IM | Interference |
| | | Measurement, |
| 30 | IMC | Intermodulation, IP |
| | | Multimedia |
| | | IMS |
| | | Credentials |
| 35 | IMEI | International |
| | | Mobile |
| | | Equipment |
| | | Identity |
| | IMGI | International |
| | | mobile group identity |
| 40 | IMPI | IP Multimedia |
| | | Private Identity |
| | IMPU | IP Multimedia |
| | | PUblic identity |
| 45 | IMS | IP Multimedia |
| | | Subsystem |
| | IMSI | International |
| | | Mobile |
| | | Subscriber |
| | | Identity |
| 50 | IOT | Internet of |
| | | Things |
| | IP | Internet |
| | | Protocol |
| 55 | Ipsec | IP Security, |
| | | Internet Protocol |
| | | Security |
| | IP-CAN | IP-Connectivity |
| | | Access Network |
| 60 | IP-M | IP Multicast |
| | IPv4 | Internet |
| | | Protocol Version 4 |
| | IPv6 | Internet |
| | | Protocol Version 6 |
| 65 | IR | Infrared |
| | IS | In Sync |
| | IRP | Integration |
| | | Reference Point |
| 70 | ISDN | Integrated |
| | | Services Digital |
| | | Network |
| | ISIM | IM Services |
| | | Identity Module |
| 75 | ISO | International |
| | | Organisation for |
| | | Standardisation |
| | ISP | Internet Service |
| | | Provider |
| 80 | IWF | Interworking- |
| | | Function |
| 85 | I-WLAN | Interworking |
| | | WLAN |
| | | Constraint |
| | | length |
| | | of the |
| | | convolutional |
| | | code, |
| | | USIM |
| | | Individual key |
| 90 | kB | Kilobyte (1000 |
| | | bytes) |
| | kbps | kilo-bits per |
| | | second |
| | Kc | Ciphering key |
| 95 | Ki | Individual |
| | | subscriber |
| | | authentication |
| | | key |
| | KPI | Key |
| | | Performance Indicator |
| | 100 KQI | Key Quality |
| | | Indicator |
| | KSI | Key Set |
| | | Identifier |
| 105 | ksps | kilo-symbols |
| | | per second |
| | KVM | Kernel Virtual |
| | | Machine |
| | L1 | Layer 1 |
| | | (physical layer) |
| 5 | L1-RSRP | Layer 1 |
| | | reference signal |
| | | received power |
| | L2 | Layer 2 (data |
| | | link layer) |
| 10 | L3 | Layer 3 |
| | | (network layer) |
| | LAA | Licensed |
| | | Assisted Access |
| 15 | LAN | Local Area |
| | | Network |
| | LADN | Local |
| | | Area Data Network |
| | LBT | Listen Before |
| | | Talk |
| 20 | LCM | LifeCycle |
| | | Management |
| | LCR | Low Chip Rate |
| | LCS | Location |
| | | Services |
| 25 | LCID | Logical |
| | | Channel ID |
| | LI | Layer Indicator |
| 30 | LLC | Logical Link |
| | | Control, Low Layer |
| | | Compatibility |
| | LMF | Location |
| | | Management Function |
| | LOS | Line of |
| | | Sight |
| 35 | LPLMN | Local |
| | | PLMN |
| | LPP | LTE |
| | | Positioning Protocol |
| 40 | LSB | Least |
| | | Significant Bit |
| | LTE | Long Term |
| | | Evolution |
| | LWA | LTE-WLAN |
| | | aggregation |
| 45 | LWIP | LTE/WLAN |
| | | Radio Level |
| | IPsec | Integration with |
| | | Tunnel |
| 50 | LTE | Long Term |
| | | Evolution |
| | M2M | Machine-to- |
| | | Machine |
| 55 | MAC | Medium Access |
| | | Control |
| | | (protocol |
| | | layering context) |
| 60 | MAC | Message |
| | | authentication code |
| | | (security/encryption |
| | | context) |
| 65 | MAC-A | MAC |
| | | used for |
| | | authentication |
| | | and key |
| | | agreement |
| | | (TSG T WG3 context) |
| 70 | MAC-IMAC | used for |
| | | data integrity of |
| | | signalling messages |
| | | (TSG T WG3 context) |
| | | MANO |
| | | Management |
| | | and |
| | | Orchestration |
| 75 | MBMS | Multimedia |
| | | Broadcast and |
| | | Multicast |
| | | Service |
| 80 | MBSFN | Multimedia |
| | | Broadcast |
| | | multicast |
| | | service Single |
| | | Frequency |
| | | Network |
| 85 | MCC | Mobile Country |
| | | Code |
| | MCG | Master Cell |
| | | Group |
| 90 | MCOT | Maximum |
| | | Channel |
| | | Occupancy |
| | | Time |
| 95 | MCS | Modulation and |
| | | coding scheme |
| | MDAF | Management |
| | | Data Analytics |
| | | Function |
| 100 | MDAS | Management |
| | | Data Analytics |
| | | Service |
| | MDT | Minimization of |
| | | Drive Tests |
| 105 | ME | Mobile |
| | | Equipment |
| | MeNB | master eNB |
| | MER | Message Error |
| | | Ratio |
| 5 | MGL | Measurement |
| | | Gap Length |
| | MGRP | Measurement |
| | | Gap Repetition |
| | | Period |
| 10 | MIB | Master |
| | | Information Block, |
| | | Management |
| | | Information Base |
| | MIMO | Multiple Input |
| | | Multiple Output |
| 15 | MLC | Mobile |
| | | Location Centre |
| | MM | Mobility |
| | | Management |
| | MME | Mobility |
| 20 | | Management Entity |
| | MN | Master Node |
| | MNO | Mobile |
| | | Network Operator |
| 25 | MO | Measurement |
| | Object, | Mobile |
| | | Originated |
| | MPBCH | MTC |
| | | Physical Broadcast |
| | | CHannel |
| 30 | MPDCCH | MTC |
| | | Physical Downlink |
| | | Control |
| | | CHannel |
| 35 | MPDSCH | MTC |
| | | Physical Downlink |
| | | Shared |
| | | CHannel |
| 40 | MPRACH | MTC |
| | | Physical Random |
| | | Access |
| | | CHannel |
| | MPUSCH | MTC |
| | | Physical Uplink Shared |
| | | Channel |
| 45 | MPLS | MultiProtocol |
| | | Label Switching |
| | MS | Mobile Station |
| | MSB | Most |
| | | Significant Bit |
| 50 | MSC | Mobile |
| | | Switching Centre |
| | MSI | Minimum |
| | | System |
| | | Information, |
| 55 | MCH | Scheduling |
| | | Information |
| | MSID | Mobile Station |
| | | Identifier |
| 60 | MSIN | Mobile Station |
| | | Identification |
| | | Number |
| | MSISDN | Mobile |
| | | Subscriber ISDN |
| | | Number |
| 65 | MT | Mobile |
| | | Terminated, Mobile |
| | | Termination |
| 70 | MTC | Machine-Type |
| | | Communications |
| 75 | mMTCmassive | MTC, massive |
| | | Machine-Type |
| | | Communications |
| | MU-MIMO | Multi |
| | | User MIMO |
| 80 | MWUS | MTC |
| | | wake-up signal, |
| | | MTC WUS |
| | NACK | Negative |
| | | Acknowledgement |
| | NAI | Network |
| | | Access Identifier |
| 85 | NAS | Non-Access |
| | | Stratum, Non- Access |
| | | Stratum layer |
| 90 | NCT | Network |
| | | Connectivity |
| | | Topology |
| | NC-JT | Non-Coherent Joint |
| | | Transmission |
| 95 | NEC | Network |
| | | Capability |
| | | Exposure |
| | NE-DC | NR-E-UTRA Dual |
| | | Connectivity |
| 100 | NEF | Network |
| | | Exposure Function |
| | NF | Network |
| | | Function |
| 105 | NFP | Network |
| | | Forwarding Path |
| | NFPD | Network |
| | | Forwarding Path |
| | | Descriptor |
| 5 | NFV | Network |
| | | Functions |
| | | Virtualization |
| | NFVI | NFV |
| | | Infrastructure |
| 10 | NFVO | NFV |
| | Orchestrator | |
| | NG | Next |
| | | Generation, Next Gen |
| 15 | NGEN-DC | NG-RAN |
| | | E-UTRA-NR |
| | | Dual Connectivity |
| | NM | Network |
| | | Manager |
| | NMS | Network |
| | | Management System |
| 20 | N-POP | Network Point |
| | | of Presence |
| | NMIB, N-MIB | Narrowband MIB |
| 25 | NPBCH | Narrowband |
| | | Physical |
| | | Broadcast |
| | | CHannel |
| 30 | NPDCCH | Narrowband |
| | | Physical |
| | | Downlink |
| | | Control CHannel |
| 35 | NPDSCH | Narrowband |
| | | Physical |
| | | Downlink |
| | | Shared CHannel |
| 40 | NPRACH | Narrowband |
| | | Physical Random |
| | | Access CHannel |
| 45 | NPUSCH | Narrowband |
| | | Physical Uplink |
| | | Shared CHannel |
| 50 | NPSS | Narrowband |
| | | Primary |
| | | Synchronization |
| | | Signal |
| | NSSS | Narrowband |
| | | Secondary |
| | | Synchronization |
| | | Signal |
| 55 | NR | New Radio, |
| | | Neighbour Relation |
| | NRF | NF Repository |
| | | Function |
| 60 | NRS | Narrowband |
| | | Reference Signal |
| | NS | Network |
| | | Service |
| | NSA | Non-Standalone |
| | | operation mode |
| 65 | NSD | Network |
| | | Service Descriptor |
| | NSR | Network |
| | | Service Record |
| 70 | NSSAI | Network Slice |
| | | Selection |
| | | Assistance |
| | | Information |
| | S-NNSAI | Single-NSSAI |
| 75 | NSSF | Network Slice |
| | | Selection Function |
| | | NW Network |
| 80 | NWUSNarrowband | wake-up signal, |
| | | Narrowband WUS |
| | NZP | Non-Zero |
| | | Power |
| | | O&M Operation and |
| | | Maintenance |
| 85 | ODU2 | Optical channel |
| | | Data Unit-type 2 |
| | OFDM | Orthogonal |
| | | Frequency Division |
| | | Multiplexing |
| 90 | OFDMA | Orthogonal |
| | | Frequency Division |
| | | Multiple Access |
| | OOB | Out-of-band |
| 95 | OOS | Out of Sync |
| | OPEX | OPerating |
| | | EXpense |
| | OSI | Other System |
| | | 100 Information |
| | OSS | Operations |
| | | Support System |
| | OTA | over-the-air |
| 105 | PAPR | Peak-to- |
| | | Average Power |
| | | Ratio |
| | | PAR Peak to |
| | | Average Ratio |
| 5 | PBCH | Physical |
| | | Broadcast Channel |
| | PC | Power Control, |
| | | Personal |
| | | Computer |
| 10 | PCC | Primary |
| | | Component Carrier, |
| | | Primary CC |
| | P-CSCF | Proxy CSCF |
| | PCell | Primary Cell |
| 15 | PCI | Physical Cell |
| | | ID, Physical Cell |
| | | Identity |
| 20 | PCEF | Policy and |
| | | Charging |
| | | Enforcement |
| | | Function |
| | PCF | Policy Control |
| | | Function |
| 25 | PCRF | Policy Control |
| | | and Charging Rules |
| | | Function |
| 30 | PDCP | Packet Data |
| | | Convergence |
| | | Protocol, Packet |
| | | Data Convergence |
| | | Protocol layer |
| | PDCCH | Physical |
| | | Downlink Control |
| | | Channel |
| 35 | PDCP | Packet Data |
| | | Convergence Protocol |
| | PDN | Packet Data |
| | | Network, Public |
| | | Data Network |
| 40 | PDSCH | Physical |
| | | Downlink Shared |
| | | Channel |
| | PDU | Protocol Data |
| | | Unit |
| 45 | PEI | Permanent |
| | | Equipment Identifiers |
| | PFD | Packet Flow |
| | | Description |
| 50 | P-GW | PDN Gateway |
| | PHICH | Physical |
| | | hybrid-ARQ indicator |
| | | channel |
| | PHY | Physical layer |
| 55 | PLMN | Public Land |
| | | Mobile Network |
| | PIN | Personal |
| | | Identification |
| 60 | PM | Performance Number |
| | | Measurement |
| | PMI | Precoding |
| | | Matrix Indicator |
| | PNF | Physical |
| | | Network |
| 65 | PNFD | Physical Function |
| | | Network Function |
| | | Descriptor |
| 70 | PNFR | Physical |
| | | Network Function |
| | | Record |
| | POC | PTT over |
| | | Cellular |
| | PP, PTP | Point-to-Point |
| 75 | PPP | Point-to-Point |
| | | Protocol |
| | PRACH | Physical RACH |
| 80 | PRB | Physical |
| | | resource block |
| | PRG | Physical |
| | | resource block |
| | | group |
| 85 | ProSe | Proximity |
| | | Services, |
| | | Proximity- |
| | | Based Service |
| | PRS | Positioning |
| | | Reference Signal |
| 90 | PRR | Packet |
| | | Reception Radio |
| | PS | Packet Services |
| | PSBCH | Physical |
| | | Sidelink Broadcast |
| | | Channel |
| 95 | PSDCH | Physical |
| | | Sidelink Downlink |
| | | Channel |
| 100 | PSCCH | Physical Sidelink |
| | | Control Channel |
| | PSSCH | Physical |
| | | Sidelink Shared |
| | | Channel |
| 105 | PSFCH | physical |
| | | sidelink feedback |
| | | channel |
| | PSCell | Primary SCell |
| 5 | PSS | Primary |
| | | Synchronization |
| | | Signal |
| | PSTN | Public Switched |
| | | Telephone Network |
| 10 | PT-RS | Phase-tracking |
| | | reference signal |
| | PTT | Push-to-Talk |
| | PUCCH | Physical |
| | | Uplink Control |
| | | Channel |
| 15 | PUSCH | Physical |
| | | Uplink Shared |
| | | Channel |
| 20 | QAM | Quadrature |
| | | Amplitude |
| | | Modulation |
| | QCI | QoS class of |
| | | identifier |
| | QCL | Quasi co- |
| | | location |
| 25 | QFI | QOS Flow ID, |
| | QOS | Flow |
| | | Identifier |
| | QOS | Quality of |
| | | Service |
| 30 | QPSK | Quadrature |
| | | (Quaternary) Phase |
| | | Shift Keying |
| | QZSS | Quasi-Zenith |
| | | Satellite System |
| 35 | RA-RNTI | Random |
| | | Access RNTI |
| | RAB | Radio Access |
| | | Bearer, Random |
| | | Access Burst |
| 40 | RACH | Random Access |
| | | Channel |
| | RADIUS | Remote |
| | | Authentication Dial |
| | | In User Service |
| 45 | RAN | Radio Access |
| | | Network |
| | RAND | RANDom |
| | | number (used for |
| | | authentication) |
| 50 | RAR | Random Access |
| | | Response |
| | RAT | Radio Access |
| | | Technology |
| 55 | RAU | Routing Area |
| | | Update |
| | RB | Resource block, |
| | | Radio Bearer |
| | RBG | Resource block |
| | | group |
| 60 | REG | Resource |
| | | Element Group |
| | Rel | Release |
| | REQ | REQuest |
| 65 | RF | Radio |
| | | Frequency |
| | RI | Rank Indicator |
| | RIV | Resource |
| | | indicator value |
| | RL | Radio Link |
| 70 | RLC | Radio Link |
| | | Control, Radio |
| | | Link Control |
| | | layer |
| 75 | RLC AM | RLC |
| | | Acknowledged Mode |
| | RLC UM | RLC |
| | | Unacknowledged |
| | | Mode |
| 80 | RLF | Radio Link |
| | | Failure |
| | RLM | Radio Link |
| | | Monitoring |
| 85 | RLM-RS | Reference |
| | | Signal for RLM |
| | RM | Registration |
| | | Management |
| | RMC | Reference |
| | | Measurement Channel |
| 90 | RMSI | Remaining |
| | | MSI, Remaining |
| | | Minimum System |
| | | Information |
| 95 | RN | Relay Node |
| | RNC | Radio Network |
| | | Controller |
| | RNL | Radio Network |
| | | Layer |
| 100 | RNTI | Radio Network |
| | | Temporary |
| | | Identifier |
| | ROHC | RObust Header |
| | | Compression |
| 105 | RRC | Radio Resource |
| | | Serving |
| | | Control, Radio |
| | | Resource Control |
| | | layer |
| 5 | RRM | Radio Resource |
| | | Management |
| | RS | Reference |
| | | Signal |
| 10 | RSRP | Reference |
| | | Signal Received |
| | | Power |
| | RSRQ | Reference |
| | | Signal Received |
| | | Quality |
| 15 | RSSI | Received Signal |
| | | Strength |
| | | Indicator |
| | RSU | Road Side Unit |
| 20 | RSTD | Reference |
| | | Signal Time |
| | | difference |
| | RTP | Real Time |
| | | Protocol |
| | RTS | Ready-To-Send |
| 25 | RTT | Round Trip |
| | | Time |
| | Rx | Reception, |
| | | Receiving, Receiver |
| | S1AP | S1 Application |
| | | Protocol |
| 30 | S1-MME | S1 for |
| | | the control plane |
| | S1-U | S1 for the user |
| | | plane |
| | S-CSCF | serving |
| 35 | | CSCF |
| | S-GW | Serving |
| | | Gateway |
| 40 | S-RNTI | SRNC |
| | | Radio Network |
| | | Temporary |
| | | Identity |
| 45 | S-TMSI | SAE |
| | | Temporary Mobile |
| | | Station |
| | | Identifier |
| | SA | Standalone |
| | | operation mode |
| 50 | SAE | System |
| | | Architecture |
| | | Evolution |
| | SAP | Service Access |
| | | Point |
| | SAPD | Service Access |
| | | Point Descriptor |
| 55 | SAPI | Service Access |
| | | Point Identifier |
| | SCC | Secondary |
| | | Component Carrier, |
| | | Secondary CC |
| 60 | SCell | Secondary Cell |
| | SCEF | Service |
| | | Capability Exposure |
| | | Function |
| 65 | SC-FDMA | Single Carrier |
| | | Frequency Division |
| | | Multiple Access |
| | SCG | Secondary Cell |
| | | Group |
| 70 | SCM | Security |
| | | Context Management |
| | SCS | Subcarrier |
| | | Spacing |
| 75 | SCTP | Stream Control |
| | | Transmission |
| | | Protocol |
| 80 | SDAP | Service Data |
| | | Adaptation |
| | | Protocol, |
| | | Service Data |
| | | Adaptation |
| | | Protocol layer |
| 85 | SDL | Supplementary |
| | | Downlink |
| | SDNF | Structured Data |
| | | Storage Network |
| | | Function |
| 90 | SDP | Session |
| | | Description Protocol |
| | SDSF | Structured Data |
| | | Storage Function |
| | SDT | Small Data |
| | | Transmission |
| 95 | SDU | Service Data |
| | | Unit |
| | SEAF | Security |
| | | Anchor Function |
| | SeNB | secondary eNB |
| 100 | SEPP | Security Edge |
| | | Protection Proxy |
| | SFI | Slot format |
| | | indication |
| 105 | SFTD | Space- |
| | | Frequency Time |
| | | Diversity, SFN |
| | | and frame timing |
| | | difference |
| 5 | SFN | System Frame |
| | | Number |
| | SgNB | Secondary gNB |
| | SGSN | Serving GPRS |
| | | Support Node |
| 10 | S-GW | Serving |
| | | Gateway |
| | SI | System |
| | | Information |
| | SI-RNTI | System |
| | | Information RNTI |
| 15 | SIB | System |
| | | Information Block |
| | SIM | Subscriber |
| | | Identity Module |
| 20 | SIP | Session |
| | | Initiated Protocol |
| | SiP | System in |
| | | Package |
| | SL | Sidelink |
| 25 | SLA | Service Level |
| | | Agreement |
| | SM | Session |
| | | Management |
| | SMF | Session |
| | | Management Function |
| 30 | SMS | Short Message |
| | | Service |
| | SMSF | SMS Function |
| 35 | SMTC | SSB-based |
| | | Measurement Timing |
| | | Configuration |
| | SN | Secondary |
| | | Node, Sequence |
| | | Number |
| | SoC | System on Chip |
| 40 | SON | Self-Organizing |
| | | Network |
| | SpCell | Special Cell |
| | | SP-CSI-RNTISemi- |
| | | Persistent CSI RNTI |
| 45 | SPS | Semi-Persistent |
| | | Scheduling |
| | SQN | Sequence |
| | | number |
| | SR | Scheduling |
| 50 | | Request |
| | SRB | Signalling |
| | | Radio Bearer |
| | SRS | Sounding |
| | | Reference Signal |
| 55 | SS | Synchronization |
| | | Signal |
| | SSB | Synchronization |
| | | Signal Block |
| 60 | SSID | Service Set |
| | | Identifier |
| | SS/PBCH | Block |
| 65 | SSBRI SS/PBCH | Block |
| | | Resource |
| | | Indicator, |
| | | Synchronization |
| | | Signal Block |
| | | Resource |
| | | Indicator |
| 70 | SSC | Session and |
| | | Service |
| | | Continuity |
| 75 | SS-RSRP | Synchronization |
| | | Signal based |
| | | Reference |
| | | Signal Received |
| | | Power |
| 80 | SS-RSRQ | Synchronization |
| | | Signal based |
| | | Reference |
| | | Signal Received |
| | | Quality |
| 85 | SS-SINR | Synchronization |
| | | Signal based Signal |
| | | to Noise and |
| | | Interference Ratio |
| 90 | SSS | Secondary |
| | | Synchronization |
| | | Signal |
| | SSSG | Search Space |
| | | Set Group |
| 95 | SSSIF | Search Space |
| | | Set Indicator |
| 100 | SST | Slice/Service |
| | | Types |
| | SU-MIMO | Single User |
| | | MIMO |
| | SUL | Supplementary |
| | | Uplink |
| 105 | TA | Timing Advance, |
| | | Tracking Area |
| | TAC | Tracking Area |
| | | Code |
| | TAG | Timing |
| | | Advance Group |
| 5 | TAI | Tracking Area |
| | | Identity |
| | TAU | Tracking Area |
| | | Update |
| | TB | Transport Block |
| 10 | TBS | Transport Block |
| | | Size |
| | TBD | To Be Defined |
| 15 | TCI | Transmission |
| | | Configuration |
| | | Indicator |
| | TCP | Transmission |
| | | Communication |
| | | Protocol |
| 20 | TDD | Time Division |
| | | Duplex |
| | TDM | Time Division |
| | | Multiplexing |
| | TDMA | Time Division |
| | | Multiple Access |
| 25 | TE | Terminal |
| | | Equipment |
| 30 | TEID | Tunnel End |
| | | Point Identifier |
| | TFT | Traffic Flow |
| | | Template |
| | TMSI | Temporary |
| | | Mobile |
| | | Subscriber |
| | | Identity |
| 35 | TNL | Transport |
| | | Network Layer |
| | TPC | Transmit Power |
| | | Control |
| 40 | TPMI | Transmitted |
| | | Precoding Matrix |
| | | Indicator |
| | TR | Technical |
| | | Report |
| 45 | TRP, TRxP | Transmission |
| | | Reception Point |
| | TRS | Tracking |
| | | Reference Signal |
| | TRx | Transceiver |
| 50 | TS | Technical |
| | | Specifications, |
| | | Technical |
| | | Standard |
| 55 | TTI | Transmission |
| | | Time Interval |
| | Tx | Transmission, |
| | | Transmitting, |
| | | Transmitter |
| 60 | U-RNTI | UTRAN |
| | | Radio Network |
| | | Temporary |
| | | Identity |
| 65 | UART | Universal |
| | | Asynchronous |
| | | Receiver and |
| | | Transmitter |
| | UCI | Uplink Control |
| | | Information |
| | UE | User Equipment |
| 70 | UDM | Unified Data |
| | | Management |
| | UDP | User Datagram |
| | | Protocol |
| 75 | UDSF | Unstructured |
| | | Data Storage Network |
| | | Function |
| | UICC | Universal |
| | | Integrated Circuit |
| | | Card |
| 80 | UL | Uplink |
| | UM | Unacknowledged |
| | | Mode |
| 85 | UML | Unified |
| | | Modelling Language |
| | UMTS | Universal |
| | | Mobile |
| | | Telecommunications |
| | | System |
| 90 | UP | User Plane |
| | UPF | User Plane |
| | | Function |
| | URI | Uniform |
| | | Resource Identifier |
| 95 | URL | Uniform |
| | | Resource Locator |
| | URLLC | Ultra-Reliable and |
| | | Low Latency |
| 100 | USB | Universal Serial |
| | | Bus |
| | USIM | Universal |
| | | Subscriber Identity |
| | | Module |
| 105 | USS | UE-specific |
| | | search space |
| | UTRA | UMTS |
| | | Terrestrial Radio |
| | | Access |
| 5 | UTRAN | Universal |
| | | Terrestrial Radio |
| | | Access |
| | | Network |
| 10 | UwPTS | Uplink |
| | | Pilot Time Slot |
| | V2I | Vehicle-to- |
| | | Infrastruction |
| 15 | V2P | Vehicle-to- |
| | | Pedestrian |
| | V2V | Vehicle-to- |
| | | Vehicle |
| | V2X | Vehicle-to- |
| | | everything |
| 20 | VIM | Virtualized |
| | | Infrastructure Manager |
| | VL | Virtual Link, |
| 25 | VLAN | Virtual LAN, |
| | | Virtual Local Area |
| | | Network |
| | VM | Virtual |
| | | Machine |
| | VNF | Virtualized Network |
| | | Function |
| 30 | VNFFG | VNF |
| | | Forwarding Graph |
| | VNFFGD | VNF |
| | | Forwarding Graph |
| | | Descriptor |
| 35 | VNFM | VNF Manager |
| | VOIP | Voice-over-IP, |
| | | Voice-over- Internet |
| | | Protocol |
| 40 | VPLMN | Visited |
| | | Public Land Mobile |
| | | Network |
| | VPN | Virtual Private |
| | | Network |
| 45 | VRB | Virtual |
| | | Resource Block |
| 50 | WiMAX | Worldwide |
| | | Interoperability |
| | | for Microwave |
| | | Access |
| | WLANWireless | Local |
| | | Area Network |
| 55 | WMAN | Wireless |
| | | Metropolitan Area |
| | | Network |
| | WPANWireless | Personal Area |
| | | Network |
| | X2-C | X2-Control |
| | | plane |
| 60 | X2-U | X2-User plane |
| | XML | extensible |
| | | Markup |
| | | Language |
| 65 | XRES | Expected user |
| | | RESponse |
| | XOR | exclusive OR |
| | ZC | Zadoff-Chu |
| | ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. An apparatus for use in a user equipment (UE), wherein the apparatus comprises:
memory to store information related to a set of sidelink resources for transmission of a sidelink message, wherein the set of sidelink resources is in unlicensed spectrum, and wherein the set of sidelink resources includes respective individual resource blocks (RBs) that are interleaved in the frequency domain; and
one or more processors configured to identify the sidelink message received on the set of sidelink resources or facilitate transmission of the sidelink message on the set of sidelink resources.

22. The apparatus of claim 21, wherein a resource pool of K RBs is divided into M subchannels of N RBs, wherein the set of sidelink resources is one of the M subchannels, and wherein a remaining K−M*N RBs are not used for sidelink transmission.

23. The apparatus of claim 21, wherein the one or more processors are further configured to identify a received radio resource control (RRC) message to indicate a resource pool for sidelink communication, wherein the RRC includes an indication that interleaved RB mapping is used for the resource pool, and wherein the set of sidelink resources is identified based on the indication.

24. The apparatus of claim 23, wherein the indication is a cell-specific indication based on a regional requirement for sidelink communication in unlicensed spectrum.

25. The apparatus of claim 23, wherein the one or more processors are further configured to identify received configuration information to indicate a set of interlaces of the resource pool that are included in the set of sidelink resources, wherein the configuration information includes one or more of:
an indication of a lowest or highest RB of the set of interlaces or of respective interlaces of the set of interlaces;
a number of consecutive interlaces in the frequency domain to be used;
a size of interlaced physical resource blocks (PRBs);
an allowed frequency resource allocation per listen-before-talk (LBT) type; or
a bitmap to indicate the set of interlaces.

26. The apparatus of claim 21, wherein the one or more processors are further configured to identify a received message to configure a number of interlaces into which a subchannel in the set of sidelink resources is mapped.

27. The apparatus of claim 21, wherein the set of sidelink resources is a first set of sidelink resources, and wherein the instructions, when executed, further configure the UE to:
identify a second set of sidelink resources that includes RBs adjacent to respective RBs of the first set of sidelink resources; and
transmit or receive, simultaneously with the transmission or reception of the sidelink message on the first set of sidelink resources, the sidelink message or another sidelink message on the second set of sidelink resources and an intra-cell guard band between the first and second sets of sidelink resources.

28. One or more non-transitory computer-readable media (NTCRM) having instructions, stored thereon, that when executed by one or more processors of a user equipment (UE) configure the UE to:
identify a resource allocation for a physical sidelink feedback channel (PSFCH) or a sidelink synchronization signal block (S-SSB); and
apply a cyclic prefix extension immediately prior to the resource allocation.

29. The one or more NTCRM of claim 28, wherein the cyclic prefix extension has a length of
$${T}_{symb , ( l - 1 ) mod 7 \cdot {2}^{μ}}^{μ} - Y$$
wherein l is a symbol in which the cyclic prefix extension is applied, μ is a value based on a subcarrier spacing, and Y is a time period.

30. The one or more NTCRM of claim 29, wherein Y is less than or equal to 16 microseconds.

31. The one or more NTCRM of claim 28, wherein the cyclic prefix extension is applied prior to the PSFCH or the S-SSB if a prior sidelink transmission of the UE or another UE is to end one symbol before a start of the PSFCH or the S-SSB.

32. The one or more NTCRM of claim 28, wherein the S-SSB is transmitted outside of a channel occupancy time of the UE, and wherein a listen-before-talk type 2A is used for the SSB if one or more of:
the S-SSB transmission is at most 1 millisecond long; or
a duty cycle of the S-SSB is at most 1/20 over an observation period.

33. The one or more NTCRM of claim 28, wherein the instructions, when executed, are further to configure the UE to perform a listen-before-talk (LBT) procedure prior to transmission of the PSFCH, wherein the LBT procedure stops at a designated time that is the same for all UEs communicating on a same sidelink carrier.

34. A user equipment (UE) comprising:
one or more processors; and
one or more non-transitory computer-readable media (NTCRM) having instructions, stored thereon, that when executed by the one or more processors configure the UE to:
identify received configuration information to indicate two starting symbols that are allowed for a sidelink transmission of the UE; and
send the sidelink transmission based on the configuration information.

35. The UE of claim 34, wherein the two starting symbols correspond to respective starting positions within a slot.

36. The UE of claim 34, wherein the two starting symbols correspond to any symbol within a pre-configured set of values.

37. The UE of claim 34, wherein the instructions, when executed, further configure the UE to apply a pre-configured cyclic prefix extension prior to the sidelink transmission.

38. The UE of claim 34, wherein the instructions, when executed, further configure the UE to perform a listen-before-talk procedure prior to the sidelink transmission.

39. The UE of claim 34, wherein the LBT procedure stops at a designated time that is the same for all UEs communicating on a same sidelink carrier.

40. The UE of claim 34, wherein the sidelink transmission is a physical sidelink shared channel (PSSCH) or a physical sidelink control channel (PSCCH).
